(19) United States
(12) Patent Application Publication
(10) Pub. No.: US 2023/0128306 A1
(43) Pub. Date: Apr. 27, 2023

(54) OPEN-LOOP POWER CONTROL PARAMETER SET INDICATION FOR MULTIPLE DOWNLINK CONTROL INFORMATION PHYSICAL UPLINK SHARED CHANNEL MESSAGES

(71) Applicant: QUALCOMM Incorporated, San Diego, CA (US)

(72) Inventors: Mostafa KHOSHNEVISAN, San Diego, CA (US); Jing SUN, San Diego, CA (US); Xiaoxia ZHANG, San Diego, CA (US)

(21) Appl. No.: 17/452,453

(22) Filed: Oct. 27, 2021

(51) Int. Cl. H04W 52/10; H04W 72/12; H04W 52/14; H04L 5/00

(52) U.S. Cl. CPC H04W 52/10; H04W 72/1289; H04W 52/146; H04L 5/0048

(57) ABSTRACT

Various aspects of the present disclosure generally relate to wireless communication. In some aspects, a user equipment (UE) may receive, from a base station, configuration information indicating a first set of open-loop power control parameters associated with a first control resource set (CORESET) pool index value and a second set of open-loop power control parameters associated with a second CORESET pool index value. The UE may receive, via a first CORESET, a first downlink control information (DCI) message that schedules a first physical uplink shared channel (PUSCH) message. The UE may transmit the first PUSCH message using a transmit power level, based on the first set of open-loop power control parameters or the second set of open-loop power control parameters, based on a CORESET pool index value associated with the first CORESET. Numerous other aspects are provided.

### FIELD OF THE DISCLOSURE

Aspects of the present disclosure generally relate to wireless communication and specifically, to techniques and apparatuses for open-loop power control parameter set indication for multiple downlink control information (DCI) physical uplink shared channel (PUSCH) messages.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

Open-loop power control (OLPC) is a technique used by a user equipment (UE) to control transmission power (for example, uplink transmission power) of the UE. In OLPC, the UE may perform power control without feedback from a base station. For example, the UE may receive a reference signal, estimate a signal strength of the reference signal, and adjust a transmit power of the UE based at least in part on the signal strength and a configuration of the UE. OLPC can be contrasted with closed-loop power control, in which the UE adjusts transmit power in accordance with a command received from a base station indicating to increase or decrease the transmit power.

In some cases, multiple downlink control information (DCI) scheduling may be used to schedule uplink communications for the UE. For example, the UE may receive a first DCI message that schedules the UE to transmit a first physical uplink shared channel (PUSCH) message and a second DCI message that schedules the UE to transmit a second PUSCH message. Multiple DCI (multi-DCI) scheduling may be contrasted with single-DCI based scheduling, where a single DCI schedules multiple PUSCH messages. A DCI that schedules a single PUSCH message, or schedules a PUSCH message for a single transmission reception point (TRP), may indicate open-loop power control parameters from a single set of open-loop power control parameters (for example, from a single P0-PUSCH-SetList). For example, one or more sets of open-loop power control parameters may be configured, such as in a radio resource control (RRC) configuration, and the DCI may indicate one or more open-loop power control parameters from a single set of open-loop power control parameters from the one or more configured sets of open-loop power control parameters.

It may be beneficial in some cases, such as in multiple TRP (multi-TRP) scenarios, to have multiple sets of open-loop power control parameters to provide additional flexibility adjusting transmit power levels to a UE. For example, in multi-TRP scenarios, a first set of open-loop power control parameters may be used to determine a transmit power level for a first TRP and a second set of open-loop power control parameters may be used to determine a second transmit power level for a second TRP. However, the DCI that schedules an uplink communication, such as a PUSCH communication, in a multi-DCI multi-TRP scenario may include only a single sounding reference signal (SRS) resource indicator (SRI) field (or no SRI field). A value indicated by an SRI field may be associated with (for example, mapped to) a set of configured open-loop power control parameters. For example, an SRI field may identify an SRS resource or an SRS resource set. An SRI value (for example, a codepoint) may be mapped to, or associated with, one or more sets of open-loop power control parameters. The DCI may further include a single open-loop power control parameter set indication field. The SRI field and the open-loop power control parameter set indication field may be used by the UE to identify an entry in the set of configured open loop power control parameters to be used for OLPC of an uplink transmission scheduled by the DCI.

However, in cases where multiple sets of open-loop power control parameters are available to be used by a base station or a TRP to indicate values for one or more OLPC parameters, the same SRI value or the same open-loop power control parameter set indication field value may map to, or may be associated with, each of the multiple sets of open-loop power control parameters. For example, an SRI value or a value of the open-loop power control parameter set indication field may map to entries in each of the multiple sets of open-loop power control parameters. Therefore, it may be unclear as to which set of open-loop power control parameters (for example, which P0-PUSCH-SetList) is to be used by the UE to identify a value of an open-loop power control parameter for OLPC of the uplink transmission scheduled by the DCI (for example, based at least in part on multiple sets of open-loop power control parameters being configured for the UE). For example, for a P0 parameter associated with controlling a received power level, a value of the open-loop power control parameter set indication field may indicate that P0-PUSCH-SetLists are to be used by the UE to identify a value of the P0 parameter for OLPC of the uplink transmission scheduled by the DCI. However, if multiple P0-PUSCH-SetLists are configured for the UE, the value of the open-loop power control parameter set indication field or the SRI field may map to entries in each of the multiple P0-PUSCH-SetLists. The open-loop power control parameter set indication field, or the SRI field, may not indicate from which set of configured open loop power control parameters (for example, which P0-PUSCH-SetList) the UE is to identify a value for an open-loop power control parameter, such as the P0 parameter (for example, based at least in part on multiple sets of open-loop power control parameters being configured for the UE). Therefore, there may be ambiguity for a UE as to which set of open-loop power control parameters are to be used for a given PUSCH message as part of the UE identifying a transmit power level for the given PUSCH message.

### SUMMARY

Some aspects described herein relate to a user equipment (UE) for wireless communication. The user equipment may include at least one processor and at least one memory, communicatively coupled with the at least one processor, that stores processor-readable code. The processor-readable code, when executed by the at least one processor, may be configured to cause the UE to receive, from a base station, configuration information, associated with multiple downlink control information (DCI) physical uplink shared channel (PUSCH) messages, indicating a first set of open-loop power control parameters associated with a first control resource set (CORESET) pool index value and a second set of open-loop power control parameters associated with a second CORESET pool index value. The processor-readable code, when executed by the at least one processor, may be configured to cause the UE to receive, via a first CORESET, a first DCI message that schedules a first PUSCH message. The processor-readable code, when executed by the at least one processor, may be configured to cause the UE to transmit the first PUSCH message using a transmit power level, based at least in part on the first set of open-loop power control parameters or based at least in part on the second set of open-loop power control parameters, based at least in part on a CORESET pool index value associated with the first CORESET being the first CORESET pool index value or the second CORESET pool index value, respectively.

Some aspects described herein relate to a base station for wireless communication. The base station may include at least one processor and at least one memory, communicatively coupled with the at least one processor, that stores processor-readable code. The processor-readable code, when executed by the at least one processor, may be configured to cause the base station to transmit, to a UE, configuration information, associated with multiple DCI PUSCH messages, indicating a first set of open-loop power control parameters associated with a first CORESET pool index value and a second set of open-loop power control parameters associated with a second CORESET pool index value. The processor-readable code, when executed by the at least one processor, may be configured to cause the base station to transmit, via a first CORESET, a first DCI message that schedules a first PUSCH message, the first DCI message indicating a transmit power level to be used by the UE based at least in part on the first set of open-loop power control parameters, the second set of open-loop power control parameters, and a CORESET pool index value associated with the first CORESET. The processor-readable code, when executed by the at least one processor, may be configured to cause the base station to receive, from the UE, the first PUSCH message that is transmitted by the UE using the transmit power level.

Some aspects described herein relate to a method of wireless communication performed by a UE. The method may include receiving, from a base station, configuration information, associated with multiple DCI PUSCH messages, indicating a first set of open-loop power control parameters associated with a first CORESET pool index value and a second set of open-loop power control parameters associated with a second CORESET pool index value. The method may include receiving, via a first CORESET, a first DCI message that schedules a first PUSCH message. The method may include transmitting the first PUSCH message using a transmit power level, based at least in part on the first set of open-loop power control parameters or based at least in part on the second set of open-loop power control parameters, based at least in part on a CORESET pool index value associated with the first CORESET being the first CORESET pool index value or the second CORESET pool index value, respectively.

Some aspects described herein relate to a method of wireless communication performed by a base station. The method may include transmitting, to a UE, configuration information, associated with multiple DCI PUSCH messages, indicating a first set of open-loop power control parameters associated with a first CORESET pool index value and a second set of open-loop power control parameters associated with a second CORESET pool index value. The method may include transmitting, via a first CORESET, a first DCI message that schedules a first PUSCH message, the first DCI message indicating a transmit power level to be used by the UE based at least in part on the first set of open-loop power control parameters, the second set of open-loop power control parameters, and a CORESET pool index value associated with the first CORESET. The method may include receiving, from the UE, the first PUSCH message that is transmitted by the UE using the transmit power level.

Some aspects described herein relate to a non-transitory computer-readable medium that stores a set of instructions for wireless communication by a UE. The set of instructions, when executed by one or more processors of the UE, may cause the UE to receive, from a base station, configuration information, associated with multiple DCI PUSCH messages, indicating a first set of open-loop power control parameters associated with a first CORESET pool index value and a second set of open-loop power control parameters associated with a second CORESET pool index value. The set of instructions, when executed by one or more processors of the UE, may cause the UE to receive, via a first CORESET, a first DCI message that schedules a first PUSCH message. The set of instructions, when executed by one or more processors of the UE, may cause the UE to transmit the first PUSCH message using a transmit power level, based at least in part on the first set of open-loop power control parameters or based at least in part on the second set of open-loop power control parameters, based at least in part on a CORESET pool index value associated with the first CORESET being the first CORESET pool index value or the second CORESET pool index value, respectively.

Some aspects described herein relate to a non-transitory computer-readable medium that stores a set of instructions for wireless communication by a base station. The set of instructions, when executed by one or more processors of the base station, may cause the base station to transmit, to a UE, configuration information, associated with multiple DCI PUSCH messages, indicating a first set of open-loop power control parameters associated with a first CORESET pool index value and a second set of open-loop power control parameters associated with a second CORESET pool index value. The set of instructions, when executed by one or more processors of the base station, may cause the base station to transmit, via a first CORESET, a first DCI message that schedules a first PUSCH message, the first DCI message indicating a transmit power level to be used by the UE based at least in part on the first set of open-loop power control parameters, the second set of open-loop power control parameters, and a CORESET pool index value associated with the first CORESET. The set of instructions, when executed by one or more processors of the base station, may cause the base station to receive, from the UE, the first PUSCH message that is transmitted by the UE using the transmit power level.

Some aspects described herein relate to an apparatus for wireless communication. The apparatus may include means for receiving, from a base station, configuration information, associated with multiple DCI PUSCH messages, indicating a first set of open-loop power control parameters associated with a first CORESET pool index value and a second set of open-loop power control parameters associated with a second CORESET pool index value. The apparatus may include means for receiving, via a first CORESET, a first DCI message that schedules a first PUSCH message. The apparatus may include means for transmitting the first PUSCH message using a transmit power level, based at least in part on the first set of open-loop power control parameters or based at least in part on the second set of open-loop power control parameters, based at least in part on a CORESET pool index value associated with the first CORESET being the first CORESET pool index value or the second CORESET pool index value, respectively.

Some aspects described herein relate to an apparatus for wireless communication. The apparatus may include means for transmitting, to a UE, configuration information, associated with multiple DCI PUSCH messages, indicating a first set of open-loop power control parameters associated with a first CORESET pool index value and a second set of open-loop power control parameters associated with a second CORESET pool index value. The apparatus may include means for transmitting, via a first CORESET, a first DCI message that schedules a first PUSCH message, the first DCI message indicating a transmit power level to be used by the UE based at least in part on the first set of open-loop power control parameters, the second set of open-loop power control parameters, and a CORESET pool index value associated with the first CORESET. The apparatus may include means for receiving, from the UE, the first PUSCH message that is transmitted by the UE using the transmit power level.

Aspects generally include a method, apparatus, system, computer program product, non-transitory computer-readable medium, user equipment, base station, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example base station in communication with a user equipment (UE) in a wireless network in accordance with the present disclosure.

FIG. 3 is a diagram illustrating an example resource structure for wireless communication, in accordance with the present disclosure.

FIG. 4 illustrates an example logical architecture of a distributed radio access network (RAN), in accordance with the present disclosure.

FIG. 5 is a diagram illustrating an example of multiple transmission reception point (multi-TRP) communication, in accordance with the present disclosure.

FIG. 6 is a diagram illustrating an example of TRP differentiation at a UE based at least in part on a control resource set (CORESET) pool index, in accordance with the present disclosure.

FIG. 7 is a diagram illustrating an example of modifying an open-loop power control parameter, in accordance with the present disclosure.

FIG. 8 is a diagram illustrating an example associated with open-loop power control parameter set indications for multiple downlink control information (DCI) physical uplink shared channel (PUSCH) messages, in accordance with the present disclosure.

FIG. 9 is a diagram illustrating an example associated with open-loop power control parameter set indications for multiple DCI (multi-DCI) PUSCH messages associated with a DCI that includes a sounding reference signal (SRS) resource indicator (SRI) field, in accordance with the present disclosure.

FIG. 10 is a diagram illustrating an example associated with open-loop power control parameter set indications for multi-DCI PUSCH messages associated with a DCI that does not include an SRI field, in accordance with the present disclosure.

FIG. 11 is a flowchart illustrating an example process performed, for example, by a UE, associated with open-loop power control parameter set indications for multi-DCI PUSCH messages, in accordance with the present disclosure.

FIG. 12 is a flowchart illustrating an example process performed, for example, by a base station, associated with open-loop power control parameter set indications for multi-DCI PUSCH messages, in accordance with the present disclosure.

FIGS. 13 and 14 are diagrams of example apparatuses for wireless communication associated with open-loop power control parameter set indication for multi-DCI PUSCH messages, in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to open-loop power control parameter set indications for multiple downlink control information (DCI) physical uplink shared channel (PUSCH) messages. Some aspects more specifically relate to indicating an open-loop power control parameter, for a PUSCH message scheduled by a DCI, based at least in part on a control resource set (CORESET) in which the DCI is detected by the UE. In some aspects, a UE may be configured with a first set of open-loop power control parameters associated with a first CORESET pool index value and a second set of open-loop power control parameters associated with a second CORESET pool index value (for example, for multiple DCI (multi-DCI) PUSCH messages, such as in a multiple transmission reception point (TRP) scenario). As used herein, “multi-DCI PUSCH messages” may refer to two or more PUSCH messages that are scheduled by different respective DCI messages (for example, a first PUSCH message that is scheduled by a first DCI message and a second PUSCH message that is scheduled by a second DCI message).

The UE may receive, via a first CORESET, a first DCI message scheduling a first PUSCH message. The UE may transmit the first PUSCH message using a transmit power level, indicated by the first set of open-loop power control parameters or indicated by the second set of open-loop power control parameters, based at least in part on a CORESET pool index value associated with the first CORESET. For example, if the first CORESET is associated with the first CORESET pool index value, then the first set of open-loop power control parameters may be used by the UE to identify one or more open-loop power control parameters for the first PUSCH message. If the first CORESET is associated with the second CORESET pool index value, then the second set of open-loop power control parameters may be used by the UE to identify one or more open-loop power control parameters for the first PUSCH message.

Particular aspects of the subject matter described in this disclosure can be implemented to realize one or more of the following potential advantages. In some examples, the described techniques can be used to enable multiple sets of open-loop power control parameters to be used in multi-DCI PUSCH scenarios. Enabling multiple sets of open-loop power control parameters to be used in multi-DCI PUSCH scenarios may provide additional flexibility (for example, to a base station or a TRP) to indicate a transmit power level to be used by the UE for a PUSCH message. For example, transmit power levels for PUSCH messages associated with a first TRP may be indicated via a first set of open-loop power control parameters and transmit power levels for PUSCH messages associated with a second TRP may be indicated via a second set of open-loop power control parameters. This may improve communication performance for the PUSCH messages by providing different TRPs with the flexibility to schedule PUSCH messages using different sets of open-loop power control parameters. Additionally, ambiguity as to which set of open-loop power control parameters are to be used by a UE may be removed by using the CORESET pool index value of a CORESET in which a DCI is detected to indicate the set of open-loop power control parameters that is to be used by the UE.

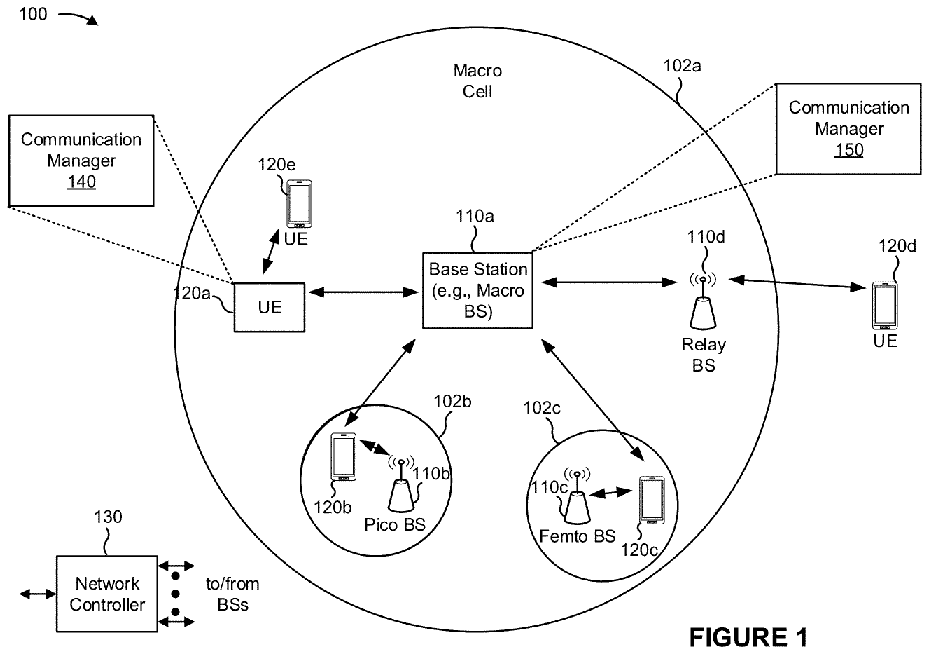

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), or other network entities. A base station 110 is an entity that communicates with UEs 120. A base station 110 (sometimes referred to as a BS) may include, for example, an NR base station, an LTE base station, a Node B, an eNB (for example, in 4G), a gNB (for example, in 5G), an access point, or a transmission reception point (TRP). Each base station 110 may provide communication coverage for a particular geographic area. In the Third Generation Partnership Project (3GPP), the term “cell” can refer to a coverage area of a base station 110 or a base station subsystem serving this coverage area, depending on the context in which the term is used.

A base station 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station.

The wireless network 100 may be a heterogeneous network that includes base stations 110 of different types, such as macro base stations, pico base stations, femto base stations, or relay base stations. These different types of base stations 110 may have different transmit power levels, different coverage areas, or different impacts on interference in the wireless network 100. For example, macro base stations may have a high transmit power level (for example, 5 to 40 watts) whereas pico base stations, femto base stations, and relay base stations may have lower transmit power levels (for example, 0.1 to 2 watts). In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (for example, three) cells. A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

In some examples, a cell may not necessarily be stationary, and the geographic area of the cell may move in accordance with the location of a base station 110 that is mobile (for example, a mobile base station). In some examples, the base stations 110 may be interconnected to one another or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a base station 110 or a UE 120) and send a transmission of the data to a downstream station (for example, a UE 120 or a base station 110). A relay station may be a UE 120 that can relay transmissions for other UEs 120. In the example shown in FIG. 1, the BS 110d (for example, a relay base station) may communicate with the BS 110a (for example, a macro base station) and the UE 120d in order to facilitate communication between the BS 110a and the UE 120d. A base station 110 that relays communications may be referred to as a relay station, a relay base station, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a base station, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the base station 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive, from a base station, configuration information, associated with multiple DCI PUSCH messages, indicating a first set of open-loop power control parameters associated with a first CORESET pool index value and a second set of open-loop power control parameters associated with a second CORESET pool index value; receive, via a first CORESET, a first DCI message that schedules a first PUSCH message; and transmit the first PUSCH message using a transmit power level, based at least in part on the first set of open-loop power control parameters or based at least in part on the second set of open-loop power control parameters, based at least in part on a CORESET pool index value associated with the first CORESET being the first CORESET pool index value or the second CORESET pool index value, respectively. Additionally or alternatively, the communication manager 140 may perform one or more other operations described herein.

In some aspects, the base station 110 may include a communication manager 150. As described in more detail elsewhere herein, the communication manager 150 may transmit, to a UE 120, configuration information, associated with multiple DCI PUSCH messages, indicating a first set of open-loop power control parameters associated with a first CORESET pool index value and a second set of open-loop power control parameters associated with a second CORESET pool index value; transmit, via a first CORESET, a first DCI message that schedules a first PUSCH message, the first DCI message indicating a transmit power level to be used by the UE 120 based at least in part on the first set of open-loop power control parameters, the second set of open-loop power control parameters, and a CORESET pool index value associated with the first CORESET; and receive, from the UE, the first PUSCH message that is transmitted by the UE 120 using the transmit power level. Additionally or alternatively, the communication manager 150 may perform one or more other operations described herein.

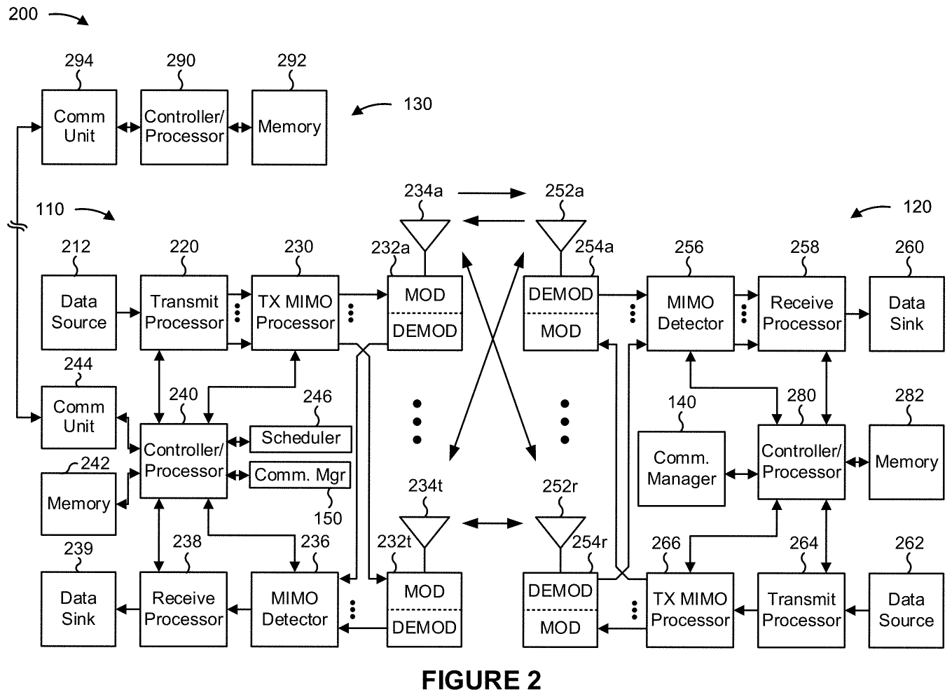

FIG. 2 is a diagram illustrating an example base station in communication with a UE in a wireless network in accordance with the present disclosure. The base station may correspond to the base station 110 of FIG. 1. Similarly, the UE may correspond to the UE 120 of FIG. 1. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the base station 110 or other base stations 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the base station 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

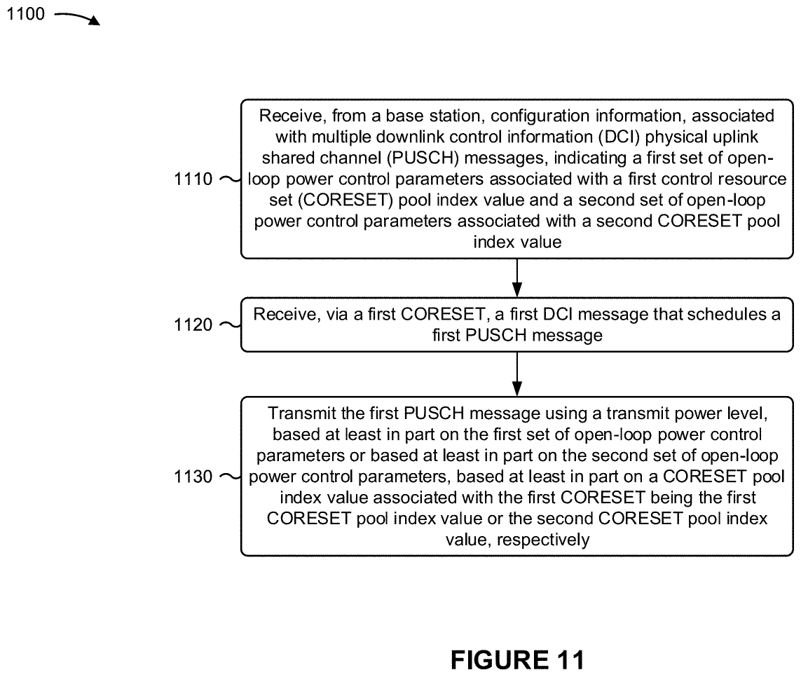

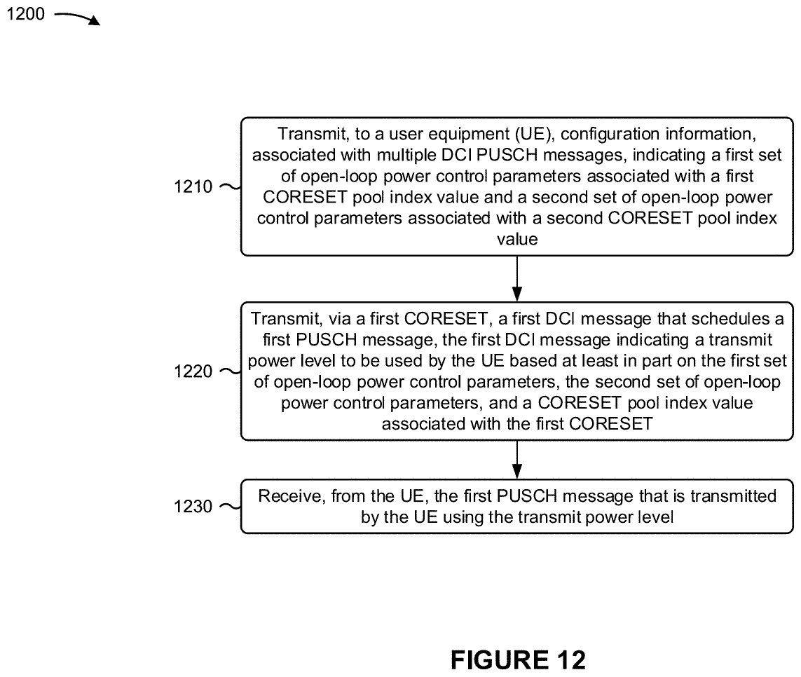

The controller/processor 240 of the base station 110, the controller/processor 280 of the UE 120, or any other component(s) of FIG. 2 may perform one or more techniques associated with open-loop power control parameter set indication for multiple DCI (multi-DCI) PUSCH messages, as described in more detail elsewhere herein. For example, the controller/processor 240 of the base station 110, the controller/processor 280 of the UE 120, or any other component(s) of FIG. 2 may perform or direct operations of, for example, process 1100 of FIG. 11, process 1200 of FIG. 12, or other processes as described herein. The memory 242 and the memory 282 may store data and program codes for the base station 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the base station 110 or the UE 120, may cause the one or more processors, the UE 120, or the base station 110 to perform or direct operations of, for example, process 1100 of FIG. 11, process 1200 of FIG. 12, or other processes as described herein. In some examples, executing instructions may include running the instructions, converting the instructions, compiling the instructions, or interpreting the instructions, among other examples.

In some aspects, the UE 120 includes means for receiving, from a base station, configuration information, associated with multi-DCI PUSCH messages, indicating a first set of open-loop power control parameters associated with a first CORESET pool index value and a second set of open-loop power control parameters associated with a second CORESET pool index value; means for receiving, via a first CORESET, a first DCI message that schedules a first PUSCH message; or means for transmitting the first PUSCH message using a transmit power level, based at least in part on the first set of open-loop power control parameters or based at least in part on the second set of open-loop power control parameters, based at least in part on a CORESET pool index value associated with the first CORESET being the first CORESET pool index value or the second CORESET pool index value, respectively. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for transmitting, to a UE, configuration information, associated with multi-DCI PUSCH messages, indicating a first set of open-loop power control parameters associated with a first CORESET pool index value and a second set of open-loop power control parameters associated with a second CORESET pool index value; means for transmitting, via a first CORESET, a first DCI message that schedules a first PUSCH message, the first DCI message indicating a transmit power level to be used by the UE based at least in part on the first set of open-loop power control parameters, the second set of open-loop power control parameters, and a CORESET pool index value associated with the first CORESET; or means for receiving, from the UE, the first PUSCH message that is transmitted by the UE using the transmit power level. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

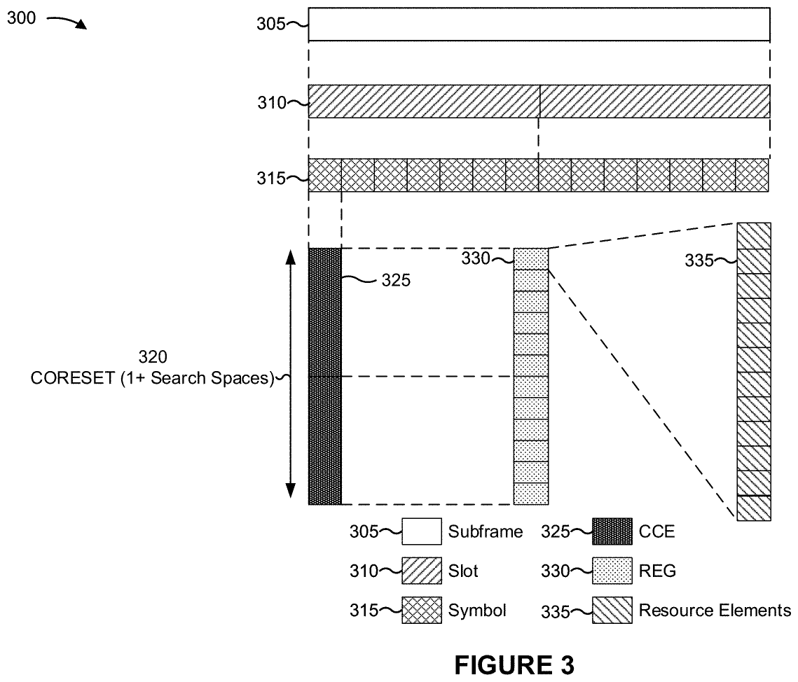

FIG. 3 is a diagram illustrating an example resource structure 300 for wireless communication, in accordance with the present disclosure. Resource structure 300 shows an example of various groups of resources described herein. As shown, resource structure 300 may include a subframe 305. Subframe 305 may include multiple slots 310. While resource structure 300 is shown as including 2 slots per subframe, a different quantity of slots may be included in a subframe (such as 4 slots, 8 slots, 16 slots, 32 slots, or another quantity of slots). In some examples, different types of transmission time intervals (TTIs) may be used, other than subframes or slots. A slot 310 may include multiple symbols 315, such as 14 symbols per slot.

The potential control region of a slot 310 may be referred to as a CORESET 320 and may be structured to support an efficient use of resources, such as by flexible configuration or reconfiguration of resources of the CORESET 320 for one or more physical downlink control channels (PDCCHs) or one or more physical downlink shared channels (PDSCHs). In some examples, the CORESET 320 may occupy the first symbol 315 of a slot 310, the first two symbols 315 of a slot 310, or the first three symbols 315 of a slot 310. Thus, a CORESET 320 may include multiple resource blocks (RBs) in the frequency domain, and either one, two, or three symbols 315 in the time domain. In 5G, a quantity of resources included in the CORESET 320 may be flexibly configured, such as by using radio resource control (RRC) signaling to indicate a frequency domain region (for example, a quantity of resource blocks) or a time domain region (for example, a quantity of symbols) for the CORESET 320.

As illustrated, a symbol 315 that includes CORESET 320 may include one or more control channel elements (CCEs) 325, shown as two CCEs 325 as an example, that span a portion of the system bandwidth. A CCE 325 may include downlink control information (DCI) that is used to provide control information for wireless communication. A base station may transmit DCI during multiple CCEs 325 (as shown), where the quantity of CCEs 325 used for transmission of DCI represents the aggregation level (AL) used by the BS for the transmission of DCI. In FIG. 3, an aggregation level of two is shown as an example, corresponding to two CCEs 325 in a slot 310. In some examples, different aggregation levels may be used, such as 1, 2, 4, 8, 16, or another aggregation level.

Each CCE 325 may include a fixed quantity of resource element groups (REGs) 330, shown as 6 REGs 330, or may include a variable quantity of REGs 330. In some examples, the quantity of REGs 330 included in a CCE 325 may be specified by a REG bundle size. An REG 330 may include one resource block, which may include 12 resource elements (REs) 335 within a symbol 315. A resource element 335 may occupy one subcarrier in the frequency domain and one OFDM symbol in the time domain.

A search space may include all possible locations (for example, in time or frequency) where a PDCCH may be located. A CORESET 320 may include one or more search spaces, such as a UE-specific search space, a group-common search space, or a common search space. A search space may indicate a set of CCE locations where a UE may find PDCCHs that can potentially be used to transmit control information to the UE. The possible locations for a PDCCH may depend on whether the PDCCH is a UE-specific PDCCH (for example, for a single UE) or a group-common PDCCH (for example, for multiple UEs) or an aggregation level being used. A possible location (for example, in time or frequency) for a PDCCH may be referred to as a PDCCH candidate, and the set of all possible PDCCH locations at an aggregation level may be referred to as a search space. For example, the set of all possible PDCCH locations for a particular UE may be referred to as a UE-specific search space. Similarly, the set of all possible PDCCH locations across all UEs may be referred to as a common search space. The set of all possible PDCCH locations for a particular group of UEs may be referred to as a group-common search space. One or more search spaces across aggregation levels may be referred to as a search space (SS) set.

A CORESET 320 may be interleaved or non-interleaved. An interleaved CORESET 320 may have CCE-to-REG mapping such that adjacent CCEs are mapped to scattered REG bundles in the frequency domain (for example, adjacent CCEs are not mapped to consecutive REG bundles of the CORESET 320). A non-interleaved CORESET 320 may have a CCE-to-REG mapping such that all CCEs are mapped to consecutive REG bundles (for example, in the frequency domain) of the CORESET 320.

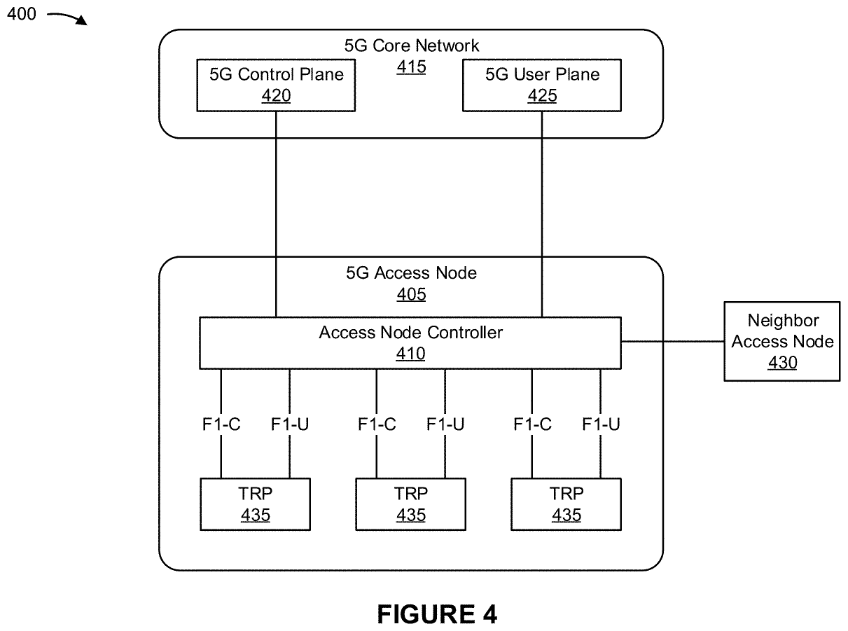

FIG. 4 illustrates an example logical architecture of a distributed radio access network (RAN) 400, in accordance with the present disclosure. A 5G access node 405 may include an access node controller 410. The access node controller 410 may be a central unit (CU) of the distributed RAN 400. In some examples, a backhaul interface to a 5G core network 415 may terminate at the access node controller 410. The 5G core network 415 may include a 5G control plane component 420 and a 5G user plane component 425 (for example, a 5G gateway), and the backhaul interface for one or both of the 5G control plane and the 5G user plane may terminate at the access node controller 410. Additionally or alternatively, a backhaul interface to one or more neighbor access nodes 430 (for example, another 5G access node 405 or an LTE access node) may terminate at the access node controller 410.

The access node controller 410 may include or may communicate with one or more TRPs 435 (for example, via an F1 Control (F1-C) interface or an F1 User (F1-U) interface). A TRP 435 may be a distributed unit (DU) of the distributed RAN 400. In some examples, a TRP 435 may correspond to a base station 110 described above in connection with FIG. 1. For example, different TRPs 435 may be included in different base stations 110. Additionally or alternatively, multiple TRPs 435 may be included in a single base station 110. In some examples, a base station 110 may include a CU (for example, access node controller 410) or one or more DUs (for example, one or more TRPs 435). In some cases, a TRP 435 may be referred to as a cell, a panel, an antenna array, or an array.

A TRP 435 may be connected to a single access node controller 410 or to multiple access node controllers 410. In some examples, a dynamic configuration of split logical functions may be present within the architecture of distributed RAN 400. For example, a packet data convergence protocol (PDCP) layer, a radio link control (RLC) layer, or a medium access control (MAC) layer may be configured to terminate at the access node controller 410 or at a TRP 435.

In some examples, multiple TRPs 435 may transmit communications (for example, the same communication or different communications) in the same transmission time interval (TTI) (for example, a slot, a mini-slot, a subframe, or a symbol) or different TTIs using different QCL relationships (for example, different spatial parameters, different transmission configuration indicator (TCI) states, different precoding parameters, or different beamforming parameters). In some examples, a TCI state may be used to indicate one or more QCL relationships. A TRP 435 may be configured to individually (for example, using dynamic selection) or jointly (for example, using joint transmission with one or more other TRPs 435) serve traffic to a UE 120.

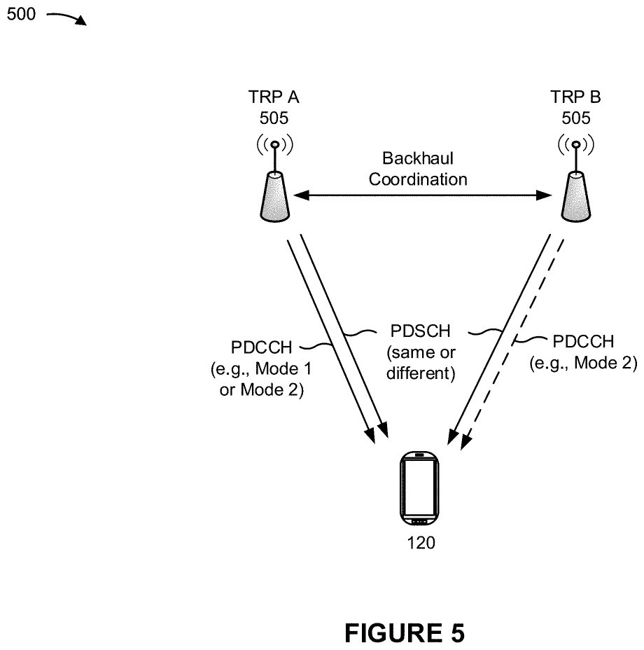

FIG. 5 is a diagram illustrating an example of multi-TRP communication 500 (sometimes referred to as multi-panel communication), in accordance with the present disclosure. As shown in FIG. 5, multiple TRPs 505 may communicate with the same UE 120. A TRP 505 may correspond to a TRP 435 described above in connection with FIG. 4.

The multiple TRPs 505 (shown as TRP A and TRP B) may communicate with the same UE 120 in a coordinated manner (for example, using coordinated multipoint transmissions) to improve reliability or increase throughput. The TRPs 505 may coordinate such communications via an interface between the TRPs 505 (for example, a backhaul interface or an access node controller 410). The interface may have a smaller delay or higher capacity when the TRPs 505 are co-located at the same base station 110 (for example, when the TRPs 505 are different antenna arrays or panels of the same base station 110), and may have a larger delay or lower capacity (as compared to co-location) when the TRPs 505 are located at different base stations 110. The different TRPs 505 may communicate with the UE 120 using different QCL relationships (for example, different TCI states), different demodulation reference signal (DMRS) ports, or different layers (for example, of a multi-layer communication).

In a first multi-TRP transmission mode (for example, Mode 1), a single PDCCH may be used to schedule downlink data communications for a single physical downlink shared channel (PDSCH). In such examples, multiple TRPs 505 (for example, TRP A and TRP B) may transmit communications to the UE 120 on the same PDSCH. For example, a communication may be transmitted using a single codeword with different spatial layers for different TRPs 505 (for example, where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (for example, using different sets of layers). In either case, different TRPs 505 may use different quasi co-location (QCL) relationships (for example, different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some examples, a TCI state in DCI (for example, transmitted on the PDCCH, such as DCI format 1_0 or DCI format 1_1) may indicate the first QCL relationship (for example, by indicating a first TCI state) and the second QCL relationship (for example, by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (for example, Mode 1).

In a second multi-TRP transmission mode (for example, Mode 2), multiple PDCCHs may be used to schedule downlink data communications for multiple corresponding PDSCHs (for example, one PDCCH for each PDSCH). In such examples, a first PDCCH may schedule a first codeword to be transmitted by a first TRP 505, and a second PDCCH may schedule a second codeword to be transmitted by a second TRP 505. Furthermore, first DCI (for example, transmitted by the first TRP 505) may schedule a first PDSCH communication associated with a first set of DMRS ports with a first QCL relationship (for example, indicated by a first TCI state) for the first TRP 505, and second DCI (for example, transmitted by the second TRP 505) may schedule a second PDSCH communication associated with a second set of DMRS ports with a second QCL relationship (for example, indicated by a second TCI state) for the second TRP 505. In such examples, DCI (for example, having DCI format 1_0 or DCI format 1_1) may indicate a corresponding TCI state for a TRP 505 corresponding to the DCI. The TCI field of a DCI indicates the corresponding TCI state (for example, the TCI field of the first DCI indicates the first TCI state and the TCI field of the second DCI indicates the second TCI state).

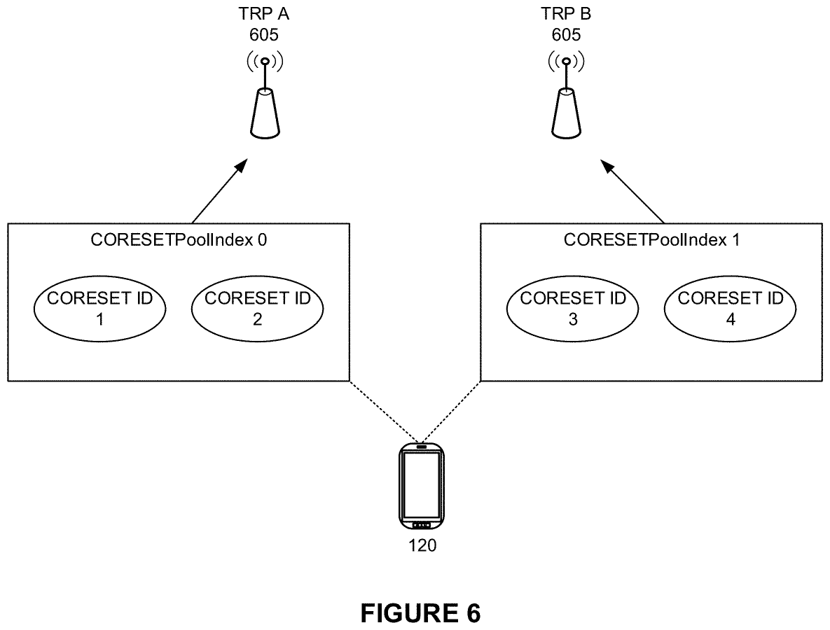

FIG. 6 is a diagram illustrating an example of TRP differentiation at a UE based at least in part on a CORESET pool index, in accordance with the present disclosure. In some examples, a CORESET pool index (or CORESETPoolIndex) value may be used by a UE (for example, a UE 120) to identify a TRP associated with an uplink grant received on a PDCCH.

As illustrated in FIG. 6, a UE 120 may be configured with multiple CORESETs in a given serving cell. Each CORESET configured for the UE 120 may be associated with a CORESET identifier (CORESET ID). For example, a first CORESET configured for the UE 120 may be associated with CORESET ID 1, a second CORESET configured for the UE 120 may be associated with CORESET ID 2, a third CORESET configured for the UE 120 may be associated with CORESET ID 3, and a fourth CORESET configured for the UE 120 may be associated with CORESET ID 4.

As further illustrated in FIG. 6, two or more (for example, up to five) CORESETs may be grouped into a CORESET pool. Each CORESET pool may be associated with a CORESET pool index. As an example, CORESET ID 1 and CORESET ID 2 may be grouped into CORESET pool index 0, and CORESET ID 3 and CORESET ID 4 may be grouped into CORESET pool index 1. In a multi-TRP configuration, each CORESET pool index value may be associated with a particular TRP 605. As an example, and as illustrated in FIG. 6, a first TRP 605 (TRP A) may be associated with CORESET pool index 0 and a second TRP 605 (TRP B) may be associated with CORESET pool index 1. The UE 120 may be configured by a higher layer parameter, such as PDCCH-Config parameter, with information identifying an association between a TRP and a CORESET pool index value assigned to the TRP. Accordingly, the UE may identify the TRP that transmitted a DCI uplink grant by determining the CORESET ID of the CORESET in which the PDCCH carrying the DCI uplink grant was transmitted, determining the CORESET pool index value associated with the CORESET pool in which the CORESET ID is included, and identifying the TRP associated with the CORESET pool index value.

Open-loop power control (OLPC) is a technique used by a UE to control transmission power (for example, uplink transmission power) of the UE. In OLPC, the UE may perform power control without feedback from a base station. For example, the UE may receive a reference signal, estimate a signal strength of the reference signal, and adjust a transmit power of the UE based at least in part on the signal strength and a configuration of the UE. OLPC can be contrasted with closed-loop power control, in which the UE adjusts transmit power in accordance with a command received from a base station indicating to increase or decrease the transmit power.

In some examples, uplink transmit power control may be performed using open-loop parameters or closed loop parameters in accordance with an equation:

$${P}_{PUSCH , b , f , c} ( i , j , {q}_{d} , l ) = min \{ \begin{matrix}{P}_{CMAX , f , c} ( i ) , \\ \begin{matrix}{P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix}\end{matrix} \}$$

where P_{PUSCH} is a physical uplink shared channel (PUSCH) power, P_{O} (which may be termed ‘P0’), α (which may be termed ‘alpha’), and pathloss (PL) are open-loop parameters. The parameter f may be a closed loop parameter that is based on a transmit power control (TPC) command with a closed loop index l. The open-loop parameter P0 may be based at least in part on a nominal PUSCH power and a UE PUSCH power, such that:

P_{O_PUSCH}=P_{O_NOMINAL_PUSCH}+P_{O_UE_PUSCH}

The P0 parameter may be a value for controlling a received power level (for example, a power level as received by a base station or a TRP). For example, the P0 parameter may be a target received PUSCH power level parameter. The alpha parameter may be a pathloss adjustment factor parameter. For example, the alpha parameter may indicate a value for partial pathloss compensation. The PL parameter may be a value that is based on a measured downlink reference signal (for example, a downlink reference signal with the index q_{d}).

For uplink transmissions, such as PUSCH transmissions, a set of uplink power control parameters may be configured. For example, the UE may receive signaling configuring a set of P0 values and alpha values for OLPC, such as in one or more P0-PUSCH-AlphaSets. In some examples, each P0-PUSCH-AlphaSet indicates a pair of values for P0 and alpha. Additionally, each P0-PUSCH-AlphaSet may be associated with an identifier, such as a P0-PUSCH-AlphaSetID. In some examples, a set of pathloss reference signals may be configured. When the UE receives DCI scheduling a PUSCH, the DCI may include an SRS resource indicator (SRI) field that maps to one of the P0-PUSCH-AlphaSet pairs of values based at least in part on a pre-configured mapping configuration (for example, in an sri-PUSCH-MappingToAddModList configuration). For example, the UE may receive an RRC configuration that maps an SRI value (for example, SRI codepoints) to an P0-PUSCH-AlphaSetID. For example, an SRI value (such as an SRI-PUSCH-PowerControl identifier) may be mapped to an P0-PUSCH-AlphaSetID, a pathloss reference signal identifier, and a closed loop power control parameter index. The SRI value (such as an SRI-PUSCH-PowerControl identifier) is used as a codepoint (for example, in an SRI field in DCI) to indicate uplink power control parameters (for example, a P0 parameter, an alpha parameter, a pathloss reference signal, or a closed loop index) that are mapped to the SRI value. The UE may use the indicated uplink power control parameters to determine a transmit power level for an uplink transmission, such as a PUSCH transmission, scheduled by the DCI.

Alternatively, if the DCI does not include an SRI field, the UE may be configured to select a default pair of values for P0 and alpha, such as a first P0 and alpha pair in a first P0-PUSCH-AlphaSet that is configured. With reference to closed loop power control, the closed loop parameter f may be based on an uplink transmit power control command δ (which may be termed delta). The delta value may be an absolute delta value, or an accumulated delta value, among other examples.

Although some aspects are described herein in terms of PUSCH power control, other uplink channel power control schemes are contemplated, such as physical uplink control channel (PUCCH) power control, SRS power control, or physical random access channel (PRACH) power control, among other examples.

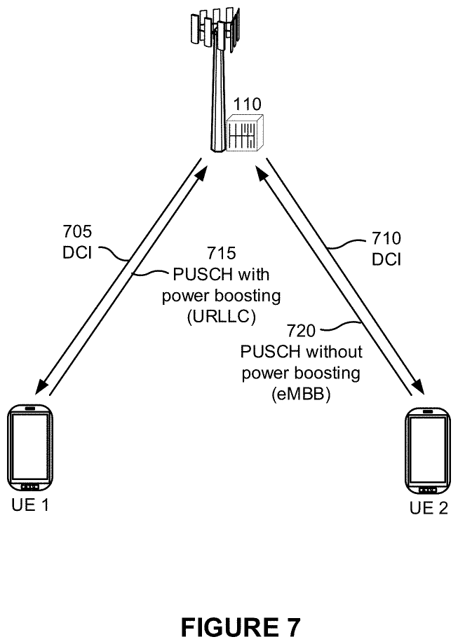

FIG. 7 is a diagram illustrating an example of modifying an open-loop power control parameter, in accordance with the present disclosure. The example depicted in FIG. 7 may be associated with boosting a transmit power for a UE. As used herein, “boosting” or a “boosted” transmit power may refer to an increased transmit power level. As shown in FIG. 7, a first UE (UE 1) and a second UE (UE 2) may communicate with a base station 110. The base station 110 may be, or may include, a TRP.

Some wireless networks, such as an NR wireless network, may support dynamic multiplexing of traffic associated with different services. For example, the wireless network may support dynamic multiplexing of traffic associated with different priorities or quality of service identifiers, such as ultra-reliable low latency communication (URLLC) traffic and enhanced mobile broadband (eMBB) traffic. “eMBB service” may refer to a service associated with low priority traffic and “URLLC service” may refer to a service associated with high priority traffic. Dynamic multiplexing may include scheduling an urgent transmission (for example, associated with a URLLC service) of the first UE on a resource that overlaps (for example, in the time domain) with a non-urgent transmission (for example, associated with an eMBB service) of the second UE. In such examples, the base station 110 may indicate, to the first UE, to boost a transmit power for the urgent transmission in order to mitigate interference from the non-urgent transmission. The transmit power levels for the boosted and non-boosted transmissions may be defined using OLPC power levels. For example, the base station 110 may modify a P0 parameter to be used by the first UE to indicate a boosted transmit power level.

For example, the base station 110 may indicate whether a transmit power level is to be boosted using a parameter in DCI. The parameter may be an open-loop power control parameter set indication parameter. For example, DCI, such as DCI that uses DCI format 0_1 or DCI format 0_2, may include an open-loop power control parameter set indication field. Whether a transmit power for an uplink transmission is boosted or modified may be based at least in part on the open-loop power control parameter set indication field. The open-loop power control parameter set indication field may be present in DCI if an RRC parameter associated with a P0 PUSCH set list (for example, a P0-PUSCH-SetList-r16 RRC parameter) is configured. A UE may interpret the open-loop power control parameter set indication field differently based on whether an SRI field is present in the DCI.

For example, there are different mechanisms for indicating OLPC power levels depending on whether an SRI is configured in the DCI that schedules the PUSCH. An SRI field can be configured (for example, present) or not configured (for example, not present) for some DCI formats such as DCI format 0_1 or DCI format 0_2. If the SRI is configured in a DCI format, then the DCI format may only be configurable with a one-bit open-loop power control parameter set indication field. In such examples, for each SRI codepoint (that is, each value indicatable in the SRI field), the UE may be configured with a corresponding power parameter set (for example, P0-PUSCH-AlphaSet, which indicates an OLPC power level defined by a P0 value) and a corresponding boosted power parameter set (for example, a P0-PUSCH-set, which indicates an OLPC power level defined by a P0 value). A P0 value indicated for the power parameter set may denote an unmodified or not boosted transmit power, and a P0 value indicated for the boosted power parameter set may denote a modified or a boosted transmit power. In such examples, for a given SRI, there may be no distinction between a not boosted power for an eMBB transmission and for a URLLC transmission, and different SRI values may be used to distinguish between eMBB and URLLC. For example, a first SRI value may be mapped to an SRS resource set for eMBB transmission, and a second SRI value may be mapped to an SRS resource set for URLLC transmission. The UE may receive DCI carrying an SRI field. The SRI may indicate a value (for example, a codepoint) that maps to P0-PUSCH-AlphaSet and P0-PUSCH-set parameter sets. For example, a value (a codepoint) of the SRI field may be mapped to a P0-PUSCH-set identifier value and a p0-PUSCH-alphaSet identifier value of P0-PUSCH-AlphaSet and P0-PUSCH-set. The UE may first determine the corresponding P0-PUSCH-AlphaSet and P0-PUSCH-set parameter set corresponding to a received codepoint in the SRI field (because the received codepoint points to a not boosted power parameter set and a boosted power parameter set), then may determine which P0 value (for example, out of the boosted power parameter set indicated by P0-PUSCH-set and the not boosted power parameter set indicated by P0-PUSCH-AlphaSet) is to be used based at least in part on the one-bit open-loop power control parameter set indication field. For example, if the open-loop power control parameter set indication field indicates a value of 0, then the UE may use the P0 contained in P0-PUSCH-AlphaSet. Alternatively, if the open-loop power control parameter set indication field indicates a value of 1, then UE may use the P0 value configured in P0-PUSCH-set.

If the SRI field is not configured in the DCI format, then the UE may be configured with 1 or 2 bits for the open-loop power control parameter set indication field in the DCI. The UE may be configured with P0-PUSCH-AlphaSet and P0-PUSCH-Set, where there can be up to two P0 values configured in P0-PUSCH-Set. The UE may use a P0 value from P0-PUSCH-AlphaSet if the open-loop power control parameter set indication field is “0” or “00.” The UE may use the first value in P0-PUSCH-Set if the open-loop power control parameter set indication field is “1” or “01.” The UE may use the second value in P0-PUSCH-Set if the open-loop power control parameter set indication is “10.”

For example, in a first operation 705, the base station 110 may transmit, and the first UE may receive, DCI scheduling a first PUSCH communication. The first PUSCH communication may be a URLLC PUSCH communication. Therefore, the DCI may indicate (for example, using an open-loop power control parameter set indication field or an SRI field in the DCI) that the first UE is to use a boosted or modified transmit power level, in a similar manner as described above. In a second operation 710, the base station 110 may transmit, and the second UE may receive, DCI scheduling a second PUSCH communication. The second PUSCH communication may be an eMBB PUSCH communication. Therefore, the DCI may indicate (for example, using an open-loop power control parameter set indication field or an SRI field in the DCI) that the second UE is to use a not boosted or unmodified transmit power level, in a similar manner as described above.

In a third operation 715, the first UE may transmit, and the base station 110 may receive, the first PUSCH communication. For example, the first UE may determine a boosted transmit power level using a P0 parameter indicated by a P0-PUSCH-Set. The first UE may transmit the first PUSCH communication using power boosting (for example, using the boosted transmit power level). In a fourth operation 720, the second UE may transmit, and the base station 110 may receive, the second PUSCH communication. For example, the second UE may determine a not boosted or unmodified transmit power level using a P0 parameter indicated by a P0-PUSCH-AlphaSet. The second UE may transmit the second PUSCH communication without using power boosting (for example, using the unmodified or not boosted transmit power level). As a result, the first PUSCH communication that is associated with URLLC traffic or high priority traffic may be transmitted with a higher transmit power level, thereby mitigating any potential interference that may be caused by the second PUSCH message.

In some examples, a single DCI may schedule multiple PUSCH repetitions that are associated with different beams or different transmission parameters. For example, a single DCI may schedule a first set (for example, one or more) of PUSCH repetitions and a second set (for example, one or more) of PUSCH repetitions. The first set of PUSCH repetitions may be associated with a first SRS resource set, a first beam, a first precoder, or a first set of power control parameters (such as a first P0 parameter, a first alpha parameter, or other power control parameters), among other examples. The second set of PUSCH repetitions may be associated with a second SRS resource set, a second beam, a second precoder, or a second set of power control parameters (such as a second P0 parameter, a second alpha parameter, or other power control parameters), among other examples. For example, the first set of PUSCH repetitions may be associated with a first TRP and the second set of PUSCH repetitions may be associated with a second TRP.

To indicate the different beams or different transmission parameters for the different sets of PUSCH repetitions scheduled by a single DCI, the single DCI may indicate different SRS resource sets associated with the different sets of PUSCH repetitions. For example, the DCI may include two SRI fields. A first P0-PUSCH-SetList may be associated with a first SRS resource set (for example, a first SRI value) and a second P0-PUSCH-SetList may be associated with a second SRS resource set (for example, a second SRI value). Uplink power control parameters, such as a P0 parameter, for the first set of PUSCH repetitions (for example, associated with the first SRS resource set) may be indicated by the first P0-PUSCH-SetList, in a similar manner as described above. Similarly, uplink power control parameters, such as a P0 parameter, for the second set of PUSCH repetitions (for example, associated with the second SRS resource set) may be indicated by the second P0-PUSCH-SetList, in a similar manner as described above. However, the single DCI may include one open-loop power control parameter set indication field. Therefore, the open-loop power control parameter set indication field may indicate a value and the UE may use the value to identify an open-loop power control parameter from either the first P0-PUSCH-SetList or the second P0-PUSCH-SetList (for example, depending on which SRS resource set the open-loop power control parameter is to be associated with).

For example, the DCI that schedules the two sets of PUSCH repetitions includes two SRI fields. If the open-loop power control parameter set indication field indicates a value of 0, then the UE may determine a value of the P0 parameter for the first set of PUSCH repetitions based on an SRI-PUSCH-PowerControlID field that is mapped to an SRI value (for example, indicated by a first SRI field) associated with the first set of PUSCH repetitions. Similarly, the UE may determine a value of the P0 parameter for the second set of PUSCH repetitions based on an SRI-PUSCH-PowerControlID field that is mapped to an SRI value or codepoint (for example, indicated by a second SRI field) associated with the second set of PUSCH repetitions. If the open-loop power control parameter set indication field indicates a value of 1, then the UE may determine a value of the P0 parameter for the first set of PUSCH repetitions based on a P0-PUSCH-SetId that is mapped to a value (e.g., a codepoint) indicated by the first SRI field. Similarly, the UE may determine a value of the P0 parameter for the second set of PUSCH repetitions based on a P0-PUSCH-SetId that is mapped to a value (e.g., a codepoint) indicated by the second SRI field.

If the DCI that schedules the two sets of PUSCH repetitions does not include any SRI fields, then the P0 values may be indicated based on the value of the open-loop power control parameter set indication field. For example, if the open-loop power control parameter set indication field indicates a value of “00,” then the UE may determine a first P0 value (for example, associated with the first set of PUSCH repetitions) based on a first default P0 value, and may determine a second P0 value (for example, associated with the second set of PUSCH repetitions) based on a second default P0 value. The default P0 values may be indicated by one or more P0-PUSCH-AlphaSets. If the open-loop power control parameter set indication field indicates a value of “1” or “01,” then the UE may determine a first P0 value (for example, associated with the first set of PUSCH repetitions) based on a first value in a first P0-PUSCH-SetList. Similarly, the UE may determine a second P0 value (for example, associated with the second set of PUSCH repetitions) based on a first value in a second P0-PUSCH-SetList. If the open-loop power control parameter set indication field indicates a value of “10” or “11,” then the UE may determine a first P0 value (for example, associated with the first set of PUSCH repetitions) based on a second value in a first P0-PUSCH-SetList. Similarly, the UE may determine a second P0 value (for example, associated with the second set of PUSCH repetitions) based on a second value in a second P0-PUSCH-SetList.

As described in connection with FIG. 6, in some cases, multi-DCI scheduling may be used in some multi-TRP scenarios. As used herein, “multi-DCI multi-TRP” may refer to a scenario in which different DCI messages are used to schedule uplink communications associated with different TRPs. For example, a UE may be scheduled to transmit a first PUSCH message for a first TRP using a first DCI message. The UE may be scheduled to transmit a second PUSCH message for a second TRP using a second DCI message. As described in more detail elsewhere herein, a DCI that schedules a single PUSCH message, or a PUSCH message for a single TRP, may indicate open-loop power control parameters from a single set of open-loop power control parameters (for example, from a single P0-PUSCH-SetList). It may be beneficial in some cases, such as in multi-TRP scenarios, to have multiple sets of open-loop power control parameters to provide additional flexibility for indicating transmit power levels for a UE. For example, in multi-TRP scenarios, a first set of open-loop power control parameters may be used for a first TRP and a second set of open-loop power control parameters may be used for a second TRP. However, the DCI that schedules an uplink communication, such as a PUSCH communication, in a multi-DCI multi-TRP scenario may include a single SRI field (or no SRI field). For example, the DCI may include a single open-loop power control parameter set indication field. However, it may be unclear as to which set of open-loop power control parameters (for example, which P0-PUSCH-SetList) is to be used by the UE to interpret the open-loop power control parameter set indication field (for example, when multiple sets of open-loop power control parameters are configured for the UE). Therefore, there may be ambiguity for a UE as to which set of open-loop power control parameters are to be used for a given PUSCH message when the UE is identifying a transmit power level for the given PUSCH message.

Various aspects relate generally to open-loop power control parameter set indications for multi-DCI PUSCH messages. Some aspects more specifically relate to indicating an open-loop power control parameter, for a PUSCH message scheduled by a DCI, based at least in part on a CORESET in which the DCI is detected by the UE. In some aspects, a UE may be configured with a first set of open-loop power control parameters associated with a first CORESET pool index value and a second set of open-loop power control parameters associated with a second CORESET pool index value (for example, for multi-DCI PUSCH messages, such as in a multi-TRP scenario). As used herein, “multi-DCI PUSCH messages” may refer to two or more PUSCH messages that are scheduled by multiple, or different, DCI messages (for example, a first PUSCH message that is scheduled by a first DCI message and a second PUSCH message that is scheduled by a second DCI message).

The UE may receive, via a first CORESET, a first DCI message scheduling a first PUSCH message. The UE may transmit the first PUSCH message using a transmit power level, indicated by the first set of open-loop power control parameters or indicated by the second set of open-loop power control parameters, based at least in part on a CORESET pool index value associated with the first CORESET. For example, if the first CORESET is associated with the first CORESET pool index value, then the first set of open-loop power control parameters may be used by the UE to identify one or more open-loop power control parameters for the first PUSCH message. If the first CORESET is associated with the second CORESET pool index value, then the second set of open-loop power control parameters may be used by the UE to identify one or more open-loop power control parameters for the first PUSCH message.

Particular aspects of the subject matter described in this disclosure can be implemented to realize one or more of the following potential advantages. In some examples, the described techniques can be used to enable multiple sets of open-loop power control parameters to be used in multi-DCI PUSCH scenarios. Enabling multiple sets of open-loop power control parameters to be used in multi-DCI PUSCH scenarios may provide additional flexibility (for example, to a base station or a TRP) to indicate a transmit power level to be used by the UE for a PUSCH message. For example, transmit power levels for PUSCH messages associated with a first TRP may be indicated via a first set of open-loop power control parameters and transmit power levels for PUSCH messages associated with a second TRP may be indicated via a second set of open-loop power control parameters. This may improve communication performance for the PUSCH messages by providing different TRPs the flexibility to schedule PUSCH messages using different sets of open-loop power control parameters. Additionally, ambiguity as to which set of open-loop power control parameters are to be used by a UE may be removed by using the CORESET pool index value of a CORESET in which a DCI is detected to indicate the set of open-loop power control parameters that is to be used by the UE.

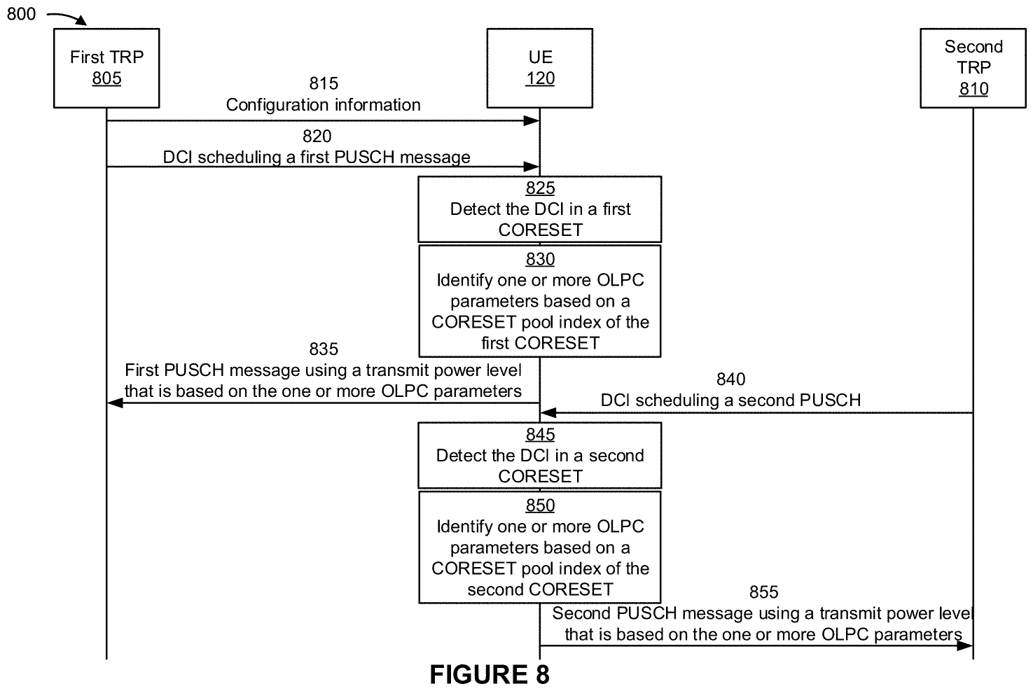

FIG. 8 is a diagram illustrating an example associated with open-loop power control parameter set indications for multi-DCI PUSCH messages 800, in accordance with the present disclosure. As shown in FIG. 8, a first TRP 805, a second TRP 810, and a UE 120 may communicate with one another in a wireless network, such as the wireless network 100. The first TRP 805 and the second TRP 810 may be associated with the same base station 110. Alternatively, the first TRP 805 and the second TRP 810 may be associated with different base stations 110. Although examples described in connection with FIG. 8 are described with reference to PUSCH messages, the techniques and operations described herein may similarly be applied to other uplink transmissions, such as PUCCH messages, random access channel (RACH) messages, SRS messages, or other types of uplink messages.

In a first operation 815, the UE 120 may receive configuration information. As shown in FIG. 8, the UE 120 may receive the configuration information from the first TRP 805. In some other aspects, the UE 120 may receive the configuration information from the second TRP 810. As another example, the UE 120 may receive the configuration information from another network entity, such as a base station 110, that is not shown in FIG. 8. In some aspects, the UE 120 may receive the configuration information via RRC signaling or MAC signaling (for example, MAC control elements (MAC-CEs)), among other examples. For example, the configuration information may be associated with an RRC configuration. In some aspects, the configuration information may include an indication of one or more configuration parameters (for example, already known to the UE 120 or hardcoded on the UE 120) for selection by the UE 120 or explicit configuration information for the UE 120 to use to configure itself.

The configuration information may be associated with multiple DCI PUSCH messages. For example, the configuration information may indicate information associated with the UE 120 transmitting PUSCH messages that are scheduled in a multi-DCI manner, as described in more detail elsewhere herein. In some aspects, the configuration information may be associated with a power control configuration. For example, the configuration information may indicate power control parameters that may be used by the UE 120 (for example, to determine a transmit power of an uplink message using open-loop power control or closed loop power control). In some aspects, the configuration information may be an open-loop power control configuration. In some aspects, the configuration information may be associated with indicating values for one or more open-loop power control parameters, such as a P0 parameter, an alpha parameter, or another open-loop power control parameter.

For example, the configuration information may indicate that the UE is to identify a set of open-loop power control parameters, from two or more sets of open-loop power control parameters, to be used for an uplink message scheduled by a DCI based at least in part on a CORESET pool index of a CORESET in which the DCI is detected. For example, the configuration information may indicate that an open-loop power control parameter set indication field in DCI is to be interpreted by the UE 120 based at least in part on a CORESET pool index of a CORESET in which the DCI is detected. For example, the configuration information may indicate a first set of open-loop power control parameters and a second set of open-loop power control parameters. The first set of open-loop power control parameters may be a first set of P0 parameter values and the second set of open-loop power control parameters may be a second set of P0 parameter values. For example, the first set of open-loop power control parameters may be a first P0-PUSCH-SetList (for example, as defined, or otherwise fixed, by a wireless communication standard, such as the 3GPP) and the second set of open-loop power control parameters may be a second P0-PUSCH-SetList.

The configuration information may indicate that the first set of open-loop power control parameters is associated with a first CORESET pool index value. For example, the configuration information may indicate that the first set of P0 parameter values or the first P0-PUSCH-SetList is associated with a first CORESET pool index value. Similarly, the configuration information may indicate that the second set of open-loop power control parameters is associated with a second CORESET pool index value. For example, the configuration information may indicate that the second set of P0 parameter values or the second P0-PUSCH-SetList is associated with a second CORESET pool index value. In other words, the configuration information may configure two or more sets of open-loop power control parameters (for example, two or more P0-PUSCH-SetLists). The configuration information may indicate, for each set of open-loop power control parameters of the two or more sets of open-loop power control parameters, a CORESET pool index value associated with the set of open-loop power control parameters. For example, the configuration information may associate or map each set of open-loop power control parameters (for example, each P0-PUSCH-SetList) to a CORESET pool index value.

Alternatively, the association of the first P0-PUSCH-SetList and the second P0-PUSCH-SetList with the CORESET pool index values may be not be indicated in the configuration information. In such examples, the UE 120 may identify the association based at least in part on the presence of the first CORESET pool index value and the second CORESET pool index value (for example, the configuration information may indicate that some CORESETs are associated or configured with the first CORESET pool index value while other CORESETs are associated or configured with the second CORESET pool index value). The UE 120 may identify, based at least in part on both CORESET pool index values being indicated by the configuration information, that the first P0-PUSCH-SetList is associated with the first CORESET pool index value and the second P0-PUSCH-SetList is associated with the second CORESET pool index value.

The CORESET pool index values may be associated with SRS resource sets or may be associated with TRPs. For example, the first CORESET pool index value may be associated with a first SRS resource set. The first SRS resource set may be associated with the first TRP 805. The second CORESET pool index value may be associated with a second SRS resource set. The second SRS resource set may be associated with the second TRP 810. For example, the first SRS resource set may be a beam, precoder, or spatial transmission direction associated with the first TRP 805. The second SRS resource set may be a beam, precoder, or spatial transmission direction associated with the second TRP 810. In other words, a first CORESET pool (for example, indicated by the first CORESET pool index value) may include one or more CORESETs associated with the first TRP 805 (for example, that may be used by the first TRP 805 to transmit DCI). A second CORESET pool (for example, indicated by the second CORESET pool index value) may include one or more CORESETs associated with the second TRP 810 (for example, that may be used by the second TRP 810 to transmit DCI).

In some aspects, each P0-PUSCH-SetList configured for the UE 120 may include one or more P0-PUSCH-SetIDs mapped to SRI values (for example, SRI codepoints). Each P0-PUSCH-SetID may be associated with a P0-List that indicates one or more P0 values. In some other aspects, each P0-PUSCH-SetList configured for the UE 120 may include a single P0-PUSCH-SetID (for example, in scenarios in which a DCI does not include an SRI field). The single P0-PUSCH-SetID may be associated with a P0-List that indicates multiple P0 values. The P0-PUSCH-SetLists, the P0-PUSCH-SetIDs, or the P0-Lists may be configured via the configuration information.

In this way, multiple sets of open-loop power control parameters (for example, multiple P0-PUSCH-SetLists) may be configured for the UE 120 for multi-DCI PUSCH communications. The UE 120 may use an open-loop power control parameter set indication field in DCI and a CORESET pool index associated with the DCI to identify a set of open-loop power control parameters, from the multiple sets of open-loop power control parameters, to use for a PUSCH message scheduled by the DCI. Although examples are described herein with configuring multiple P0-PUSCH-SetLists for the P0 parameter, similar techniques and operations may be used to indicate other open-loop power control parameters, such as the alpha parameter.

The UE 120 may configure the UE 120 for communicating with the first TRP 805 and the second TRP 810. In some aspects, the UE 120 may configure itself based at least in part on the configuration information. In some aspects, the UE 120 may be configured to perform one or more operations described herein.

In some aspects, the UE 120 may transmit (for example, to the first TRP 805, the second TRP 810, or another network entity) an indication of a capability of the UE 120 to communicate using a set of open-loop power control parameters that are indicated via a CORESET pool index of a CORESET in which a DCI is received, as described herein. For example, the UE 120 may indicate a capability of the UE 120 to communicate using one or more techniques or operations described herein. In some aspects, the UE 120 may transmit the indication via RRC signaling, one or more MAC-CEs, a UE capability report, or a PUCCH message, among other examples.

In a second operation 820, the first TRP 805 (for example, a base station 110) may transmit, and the UE 120 may receive, a first DCI message that schedules a first PUSCH message. The first TRP 805 may use a first CORESET to transmit the first DCI message. For example, the first TRP 805 may transmit the first DCI message using a CORESET of a PDCCH. The UE 120 may monitor one or more CORESETs (for example, may monitor one or more search spaces or SS sets) in accordance with the configuration information.

For example, in a third operation 825, the UE 120 may detect the first DCI message in the first CORESET. For example, based at least in part on monitoring the one or more CORESETs, the one or more search spaces, or the one or more SS sets, the UE 120 may detect the first DCI message in the first CORESET. The UE 120 may decode the first DCI message based at least in part on detecting the first DCI message.

In a fourth operation 830, the UE 120 may identify one or more open-loop power control parameters, associated with the first PUSCH message scheduled by the first DCI message, based at least in part on a CORESET pool index of the first CORESET in which the first DCI message is detected. For example, the UE 120 may identify a transmit power level for the first PUSCH message (for example, indicated by the first set of open-loop power control parameters or indicated by the second set of open-loop power control parameters) based at least in part on a CORESET pool index value associated with the first CORESET being the first CORESET pool index value or the second CORESET pool index value. For example, if the CORESET pool index value associated with the first CORESET is the first CORESET pool index value, then the UE 120 may use the first set of open-loop power control parameters to determine the transmit power level for the first PUSCH message. If the CORESET pool index value associated with the first CORESET is the second CORESET pool index value, then the UE 120 may use the second set of open-loop power control parameters to determine the transmit power level for the first PUSCH message.

For example, the UE 120 may identify a value of a P0 parameter based at least in part on the CORESET pool index of the first CORESET in which the first DCI message is detected. For example, if the CORESET pool index value associated with the first CORESET is the first CORESET pool index value, then the UE 120 may use a first P0-PUSCH-SetList to determine the value of the P0 parameter for the first PUSCH message. If the CORESET pool index value associated with the first CORESET is the second CORESET pool index value, then the UE 120 may use a second P0-PUSCH-SetList to determine the value of the P0 parameter for the first PUSCH message.

In some aspects, the UE 120 may identify the one or more open-loop power control parameters based at least in part on an open-loop power control parameter set indication field in a DCI message. For example, if the open-loop power control parameter set indication field in the first DCI message indicates a value other than zero (for example, other than “0”), then the UE 120 may use the first set of open-loop power control parameters or the second set of open-loop power control parameters to identify the one or more open-loop power control parameters for the first PUSCH message. If the open-loop power control parameter set indication field in the first DCI message indicates a value of zero, then a default open-loop power control parameter may be used for the first PUSCH message. For example, if the open-loop power control parameter set indication field in the first DCI message indicates a value of zero, then a P0 value indicated by an SRI-PUSCH-PowerControlID mapped to an SRI value indicated by the first DCI message may be used to identify a P0 value for the first PUSCH message. As another example, if the open-loop power control parameter set indication field in the first DCI message indicates a value of zero (and the first DCI message does not include an SRI field), then a P0-PUSCH-AlphaSet may be used to identify a P0 value for the first PUSCH message.

For example, the UE 120 may identify a transmit power level for the first PUSCH message based at least in part on the open-loop power control parameter set indication field in the first DCI message and a set of target received PUSCH power level (P0) parameters and pathloss adjustment factor (alpha) parameters (for example, a set of P0-PUSCH-AlphaSet parameters) based at least in part on a value of the open-loop power control parameter set indication field (for example, based at least in part on the value of the open-loop power control parameter set indication field being “0” or “00”). The UE 120 may identify a transmit power level (for example, may identify a value for the P0 parameter) for the first PUSCH message based at least in part on the open-loop power control parameter set indication field in the first DCI message and the first set of open-loop power control parameters based at least in part on the first CORESET being associated with the first CORESET pool index value. The UE 120 may identify a transmit power level (for example, may identify a value for the P0 parameter) for the first PUSCH message based at least in part on the open-loop power control parameter set indication field in the first DCI message and the second set of open-loop power control parameters based at least in part on the first CORESET being associated with the second CORESET pool index value.

In some aspects, the first DCI message may include an SRI field. In such examples, the UE 120 may identify a transmit power level for the first PUSCH message based at least in part on the value of the SRI field. For example, the SRI field may map to an entry in the first set of open-loop power control parameters (for example, the first P0-PUSCH-SetList) and to an entry in the second set of open-loop power control parameters (for example, the second P0-PUSCH-SetList). The UE 120 may identify which set of open-loop power control parameters to use based at least in part on the CORESET pool index of the first CORESET in which the first DCI message is detected. For example, the UE 120 may use the first set of open-loop power control parameters based at least in part on the first CORESET being associated with the first CORESET pool index value. Alternatively, the UE 120 may use the second set of open-loop power control parameters based at least in part on the CORESET being associated with the second CORESET pool index value.

In other words, if the first CORESET is associated with the first CORESET pool index value, then the interpretation of an open-loop power control parameter set indication field (for example, by the UE 120) in the first DCI message is based at least in part on the first set of open-loop power control parameters (for example, the first P0-PUSCH-SetList) that is mapped to, or associated with, the first CORESET pool index value. If the first CORESET is associated with the second CORESET pool index value, then the interpretation of an open-loop power control parameter set indication field (for example, by the UE 120) in the first DCI message is based at least in part on the second set of open-loop power control parameters (for example, the second P0-PUSCH-SetList) that is mapped to, or associated with, the second CORESET pool index value.

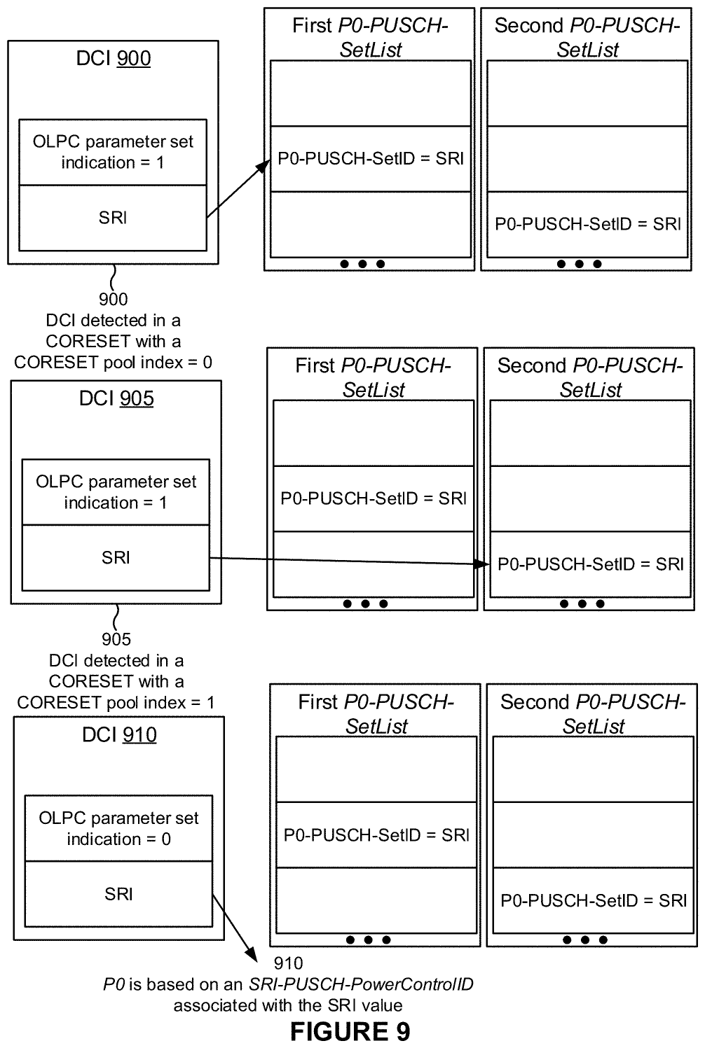

For example, after the UE 120 identifies which set of open-loop power control parameters (for example, which P0-PUSCH-SetList) is to be used to interpret the first DCI message, then UE 120 may identify whether the first DCI message includes an SRI field. If the SRI field is present or configured in the first DCI message, then the UE 120 may identify a value of the open-loop power control parameter set indication field. If the open-loop power control parameter set indication field indicates a value of “0” or “00,” then the UE 120 may determine a P0 value for the first PUSCH message based at least in part on the value of the SRI field (for example, on only the value of the SRI field). For example, the UE 120 may determine a P0 value for the first PUSCH message based at least in part on an SRI-PUSCH-PowerControlID mapped to an SRI value indicated by the first DCI message and the SRI field included in the first DCI message. If the open-loop power control parameter set indication field indicates a value other than zero (for example, indicates a value of “1”), then the UE 120 may determine a P0 value for the first PUSCH message based at least in part on a P0-PUSCH-SetId included in the identified P0-PUSCH-SetList (for example, identified based at least in part on the CORESET pool index value of the first CORESET). For example, the UE 120 may determine a P0 value for the first PUSCH message based at least in part on a P0-PUSCH-SetId, included in the identified P0-PUSCH-SetList, that is mapped to an SRI value indicated by the first DCI message and the SRI field included in the first DCI message. An interpretation of the open-loop power control parameter set indication field for DCI that includes an SRI field is depicted and described in more detail in connection with FIG. 9.

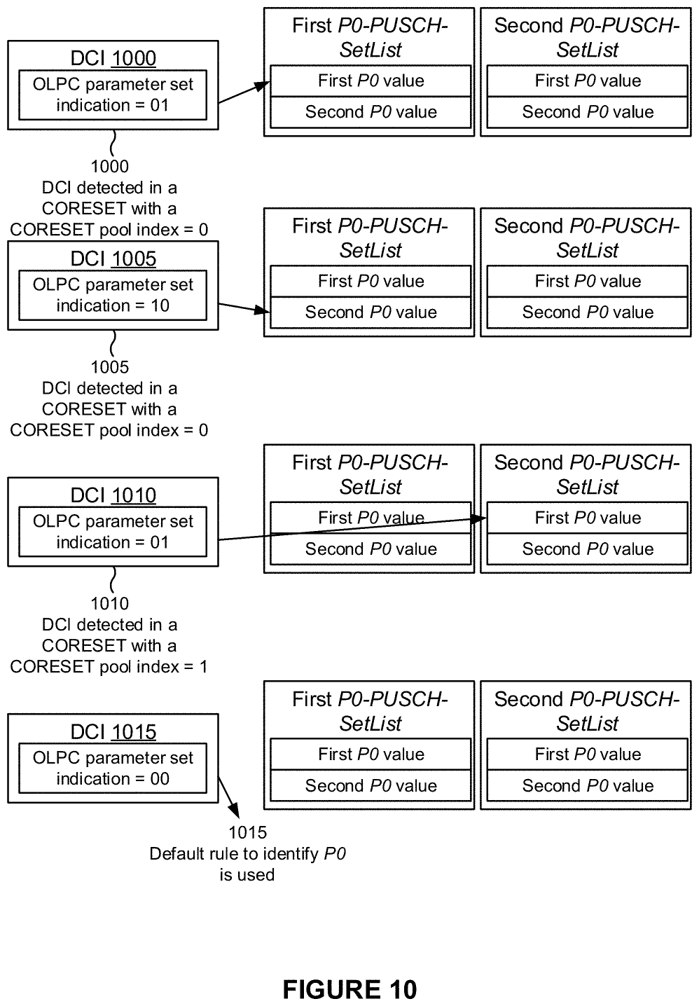

If the SRI field is not present or not configured in the first DCI message, then the UE 120 may determine a P0 value for the first PUSCH message based at least in part on a value of the open-loop power control parameter set indication field. For example, if the open-loop power control parameter set indication field indicates a value of zero (for example, indicates a value of “0” or “00”), then the UE 120 may use a default rule to determine the P0 value. For example, the UE 120 may determine the P0 value based at least in part on a first (or second) P0-PUSCH-AlphaSet (for example, first or second P0-PUSCH-AlphaSet as configured in a P0-AlphaSets configuration). If the open-loop power control parameter set indication field indicates a value other than zero, then the UE 120 may determine a P0 value for the first PUSCH message based at least in part on a P0-PUSCH-SetId included in the identified P0-PUSCH-SetList (for example, identified based at least in part on the CORESET pool index value of the first CORESET). For example, in scenarios where the SRI field is not present or not configured in the first DCI message, a single P0-PUSCH-SetId may be included in the identified P0-PUSCH-SetList. The single P0-PUSCH-SetId may indicate multiple P0 values. Which P0 value, of the multiple P0 values, is to be used by the UE 120 may be indicated by a value of the open-loop power control parameter set indication field. For example, if the open-loop power control parameter set indication field indicates a value of “1” or “01,” then a first P0 value indicated by the P0-PUSCH-SetId may be used by the UE 120. If the open-loop power control parameter set indication field indicates a value of “10” or “11,” then a second P0 value indicated by the P0-PUSCH-SetId may be used by the UE 120. An interpretation of the open-loop power control parameter set indication field for DCI that does not include an SRI field is depicted and described in more detail in connection with FIG. 10.

The UE 120 may determine a transmit power level for the first PUSCH message based at least in part on the one or more open-loop power control parameters identified as described above. For example, the UE 120 may use an identified P0 value to determine the transmit power level for the first PUSCH message. In a fifth operation 835, the UE 120 may transmit, and the first TRP 805 may receive, the first PUSCH message. The UE 120 may transmit the first PUSCH message using a transmit power level. The transmit power level may be indicated by the first set of open-loop power control parameters, or indicated by the second set of open-loop power control parameters, based at least in part on a CORESET pool index value associated with the first CORESET being the first CORESET pool index value or the second CORESET pool index value, as described in more detail elsewhere herein.

In a sixth operation 840, the second TRP 810 may transmit, and the UE 120 may receive, a second DCI message. The second TRP 810 may use a second CORESET to transmit the second DCI message. For example, the second TRP 810 may transmit the second DCI message using a CORESET of a PDCCH. The UE 120 may monitor one or more CORESETs (for example, may monitor one or more search spaces or SS sets) in accordance with the configuration information.

For example, in a seventh operation 845, the UE 120 may detect the second DCI message in the second CORESET. For example, based at least in part on monitoring the one or more CORESETs, the one or more search spaces, or the one or more SS sets, the UE 120 may detect the second DCI message in the second CORESET. The UE 120 may decode the second DCI message based at least in part on detecting the second DCI message.

In an eighth operation 850, the UE 120 may identify one or more open-loop power control parameters, associated with the second PUSCH message scheduled by the second DCI message, based at least in part on a CORESET pool index of the second CORESET in which the second DCI message is detected. For example, the UE 120 may identify a value of the P0 parameter using a P0-PUSCH-SetList, from a first P0-PUSCH-SetList and a second P0-PUSCH-SetList, based at least in part on a CORESET pool index of the second CORESET in which the second DCI message is detected. The UE 120 may determine a transmit power level or a value of the P0 parameter for the second PUSCH message in a similar (or the same) manner as described above in connection with the first PUSCH message (for example, in a similar (or the same) manner as described in connection with the third operation 825, the fourth operation 830, or the fifth operation 835).

The UE 120 may determine a transmit power level for the second PUSCH message based at least in part on the one or more open-loop power control parameters identified as described above. For example, the UE 120 may use an identified P0 value to determine the transmit power level for the second PUSCH message. In a ninth operation 855, the UE 120 may transmit, and the second TRP 810 may receive, the second PUSCH message. The UE 120 may transmit the second PUSCH message using a transmit power level. The transmit power level may be indicated by the first set of open-loop power control parameters, or indicated by the second set of open-loop power control parameters, based at least in part on a CORESET pool index value associated with the second CORESET being the first CORESET pool index value or the second CORESET pool index value, as described in more detail elsewhere herein.

In some aspects, the first PUSCH message may not overlap with the second PUSCH message in at least one of a time domain, a frequency domain, or a spatial domain. For example, the first PUSCH message and the second PUSCH message may be time division multiplexed, frequency division multiplexed, or spatial division multiplexed. In some other aspects, the first PUSCH message may be at least partially overlapping with the second PUSCH message in at least one of a time domain, a frequency domain, or a spatial domain.

As described in more detail elsewhere herein, a first transmit power level used for the first PUSCH message and a second transmit power level used for the second PUSCH message (for example, that are scheduled using different DCI messages) may be determined by the UE 120 using different sets of open-loop power control parameters. For example, multiple sets of open-loop power control parameters may be configured for the UE 120 for multi-DCI PUSCH messages, such as in a multi-TRP scenario. The UE 120 may be enabled to identify a set of open-loop power control parameters, from the multiple sets of open-loop power control parameters, to be used for a given PUSCH message based at least in part on a CORESET pool index of a CORESET in which a DCI, that schedules the given PUSCH message, is detected. As a result, the first PUSCH message and the second PUSCH message are associated with a multiple DCI PUSCH message scheme, and the first transmit power level may be independent of the second transmit power level. For example, the first transmit power level and the second transmit power level may be determined by the UE 120 using different sets of open-loop power control parameters. This provides additional flexibility to different TRPs or different base stations to indicate a transmit power level for a PUSCH message using different sets of open-loop power control parameters (for example, depending on a CORESET used by the TRP or the base station to transmit DCI that schedules the PUSCH message).

FIG. 9 is a diagram illustrating an example associated with open-loop power control parameter set indications for multi-DCI PUSCH messages associated with a DCI that includes an SRI field, in accordance with the present disclosure. As shown in FIG. 9, a first P0-PUSCH-SetList and a second P0-PUSCH-SetList may be configured for the UE 120. The configuration (for example, an RRC configuration) may map, or associate, the first P0-PUSCH-SetList with a first CORESET pool index value. The configuration may map, or associate, the second P0-PUSCH-SetList with a second CORESET pool index value. For example, the first P0-PUSCH-SetList may be associated with a CORESET pool index value of “0” and the second P0-PUSCH-SetList may be associated with a CORESET pool index value of “1.” The first P0-PUSCH-SetList and the second P0-PUSCH-SetList may be associated with one or more P0-PUSCH-SetIDs. Each P0-PUSCH-SetID may indicate a value of the P0 parameter.

As shown in FIG. 9, a DCI 900 may be detected by the UE 120 in a CORESET that is associated with a CORESET pool index value of “0.” Additionally, an open-loop power control parameter set indication field in the DCI 900 may indicate a value of “1.” Therefore, based at least in part on the open-loop power control parameter set indication field indicating a value of “1,” UE 120 may identify that a P0 parameter for a PUSCH message scheduled by the DCI 900 may be indicated by the first P0-PUSCH-SetList or the second P0-PUSCH-SetList. As shown in FIG. 9, the UE 120 may identify that the first P0-PUSCH-SetList may be used to determine a value of the P0 parameter based at least in part on the CORESET in which the DCI 900 is detected by the UE 120 being associated with a CORESET pool index value of “0.” As shown in FIG. 9, the UE 120 may identify the value of the P0 parameter using a P0-PUSCH-SetID field that is mapped to a value (or a codepoint) indicated by the SRI field in the DCI 900.

As further shown in FIG. 9, a DCI 905 may be detected by the UE 120 in a CORESET that is associated with a CORESET pool index value of “1.” Additionally, an open-loop power control parameter set indication field in the DCI 905 may indicate a value of “1.” Therefore, based at least in part on the open-loop power control parameter set indication field indicating a value of “1,” UE 120 may identify that a P0 parameter for a PUSCH message scheduled by the DCI 905 may be indicated by the first P0-PUSCH-SetList or the second P0-PUSCH-SetList. As shown in FIG. 9, the UE 120 may identify that the second P0-PUSCH-SetList may be used to determine a value of the P0 parameter based at least in part on the CORESET in which the DCI 905 is detected by the UE 120 being associated with a CORESET pool index value of “1.” As shown in FIG. 9, the UE 120 may identify the value of the P0 parameter using a P0-PUSCH-SetID field that is mapped to a value (or a codepoint) indicated by the SRI field in the DCI 905.

As further shown in FIG. 9, the UE 120 may identify that a value of the P0 parameter for a PUSCH message scheduled by a DCI 910 is not to be based at least in part on the first P0-PUSCH-SetList or the second P0-PUSCH-SetList. For example, an open-loop power control parameter set indication field in the DCI 910 may indicate a value of “0.” Therefore, the UE 120 may identify the first P0-PUSCH-SetList and the second P0-PUSCH-SetList are not to be used to identify a value of the P0 parameter for a PUSCH message scheduled by a DCI 910. Rather, the UE 120 may use a value of the SRI field of the DCI 910 to identify the value of the P0 parameter. For example, the UE 120 may use a value of the P0 parameter indicated by an SRI-PUSCH-PowerControlID that is mapped to, or associated with, the value indicated by the SRI field of the DCI 910.

FIG. 10 is a diagram illustrating an example associated with open-loop power control parameter set indications for multi-DCI PUSCH messages associated with a DCI that does not include an SRI field, in accordance with the present disclosure. As shown in FIG. 10, a first P0-PUSCH-SetList and a second P0-PUSCH-SetList may be configured for the UE 120. The configuration (for example, an RRC configuration) may map, or associate, the first P0-PUSCH-SetList with a first CORESET pool index value. The configuration may map, or associate, the second P0-PUSCH-SetList with a second CORESET pool index value. For example, the first P0-PUSCH-SetList may be associated with a CORESET pool index value of “0” and the second P0-PUSCH-SetList may be associated with a CORESET pool index value of “1.” The first P0-PUSCH-SetList and the second P0-PUSCH-SetList may be associated with one or more P0-PUSCH-SetIDs. In examples where the DCI does not include an SRI field, each P0-PUSCH-SetID may indicate multiple values for the P0 parameter. For example, as shown in FIG. 10, each P0-PUSCH-SetList may include a single PUSCH-SetID and the single PUSCH-SetID may indicate two values for the P0 parameter.

As shown in FIG. 10, a DCI 1000 may be detected by the UE 120 in a CORESET that is associated with a CORESET pool index value of “0.” Additionally, an open-loop power control parameter set indication field in the DCI 1000 may indicate a value of “01.” Based at least in part on the DCI 1000 being detected by the UE 120 in a CORESET that is associated with the CORESET pool index value of “0,” the UE 120 may identify that the first P0-PUSCH-SetList is to be used to identify a value of a P0 parameter for a PUSCH message scheduled by the DCI 1000. Additionally, based at least in part on the open-loop power control parameter set indication field in the DCI 1000 indicating a value of “01,” the UE 120 may identify that a first P0 value indicated by the PUSCH-SetID associated with the first P0-PUSCH-SetList is to be used for the PUSCH message scheduled by the DCI 1000.

As further shown in FIG. 10, a DCI 1005 may be detected by the UE 120 in a CORESET that is associated with a CORESET pool index value of “0.” Additionally, an open-loop power control parameter set indication field in the DCI 1005 may indicate a value of “10.” Based at least in part on the DCI 1005 being detected by the UE 120 in a CORESET that is associated with the CORESET pool index value of “0,” the UE 120 may identify that the first P0-PUSCH-SetList is to be used to identify a value of a P0 parameter for a PUSCH message scheduled by the DCI 1005. Additionally, based at least in part on the open-loop power control parameter set indication field in the DCI 1005 indicating a value of “10,” the UE 120 may identify that a second P0 value indicated by the PUSCH-SetID associated with the first P0-PUSCH-SetList is to be used for the PUSCH message scheduled by the DCI 1005.

As further shown in FIG. 10, a DCI 1010 may be detected by the UE 120 in a CORESET that is associated with a CORESET pool index value of “1.” Additionally, an open-loop power control parameter set indication field in the DCI 1010 may indicate a value of “01.” Based at least in part on the DCI 1010 being detected by the UE 120 in a CORESET that is associated with the CORESET pool index value of “1,” the UE 120 may identify that the second P0-PUSCH-SetList is to be used to identify a value of a P0 parameter for a PUSCH message scheduled by the DCI 1010. Additionally, based at least in part on the open-loop power control parameter set indication field in the DCI 1005 indicating a value of “01,” the UE 120 may identify that a first P0 value indicated by the PUSCH-SetID associated with the second P0-PUSCH-SetList is to be used for the PUSCH message scheduled by the DCI 1010. Alternatively, if the open-loop power control parameter set indication field in the DCI 1005 indicating a value of “10” or “11,” then the UE 120 may identify that a second P0 value indicated by the PUSCH-SetID associated with the second P0-PUSCH-SetList is to be used for the PUSCH message scheduled by the DCI 1010.

As further shown in FIG. 10, the UE 120 may identify that a value of the P0 parameter for a PUSCH message scheduled by a DCI 1015 is not to be based at least in part on the first P0-PUSCH-SetList or the second P0-PUSCH-SetList. For example, an open-loop power control parameter set indication field in the DCI 1015 may indicate a value of zero (for example, “0” or “00”). Therefore, the UE 120 may identify that the first P0-PUSCH-SetList and the second P0-PUSCH-SetList are not to be used to identify a value of the P0 parameter for a PUSCH message scheduled by a DCI 1015. Rather, the UE 120 may use a default rule to identify a value of the P0 parameter for a PUSCH message scheduled by the DCI 1015. For example, the UE 120 may identify a value for the P0 parameter from a P0-PUSCH-AlphaSet (for example, from a configured pair of P0 and alpha values). For example, the UE 120 may identify a value for the P0 parameter from a first P0-PUSCH-AlphaSet configured in a P0-PUSCH-AlphaSets configuration (for example, a P0-PUSCH-AlphaSet associated with a lowest or highest identifier or index value on the P0-PUSCH-AlphaSets configuration).

FIG. 11 is a flowchart illustrating an example process 1100 performed, for example, by a UE, associated with open-loop power control parameter set indication for multi-DCI PUSCH messages, in accordance with the present disclosure. Example process 1100 is an example where the UE (for example, UE 120) performs operations associated with open-loop power control parameter set indication for multi-DCI PUSCH messages.

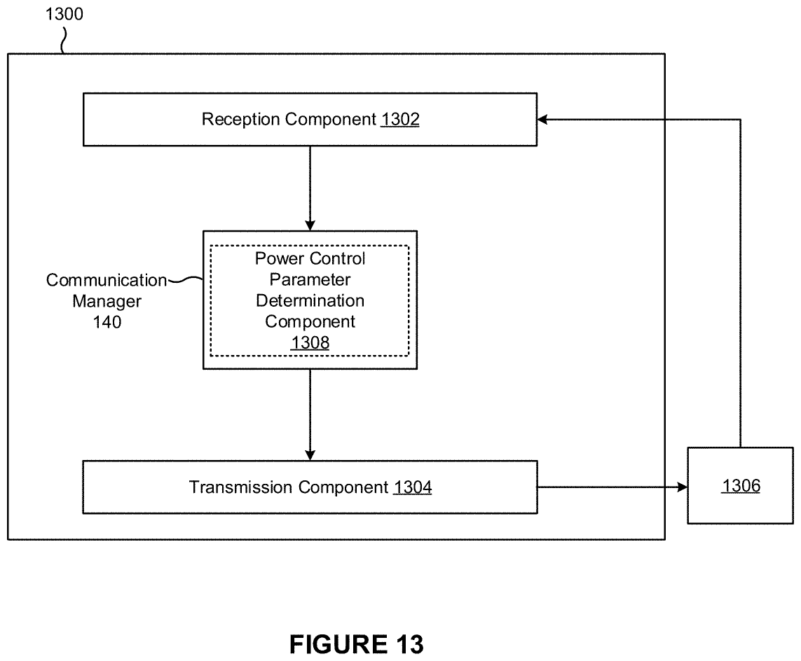

As shown in FIG. 11, in some aspects, process 1100 may include receiving, from a base station, configuration information, associated with multiple DCI PUSCH messages, indicating a first set of open-loop power control parameters associated with a first CORESET pool index value and a second set of open-loop power control parameters associated with a second CORESET pool index value (block 1110). For example, the UE (such as by using communication manager 140 or reception component 1302, depicted in FIG. 13) may receive, from a base station, configuration information, associated with multiple DCI PUSCH messages, indicating a first set of open-loop power control parameters associated with a first CORESET pool index value and a second set of open-loop power control parameters associated with a second CORESET pool index value, as described above.

As further shown in FIG. 11, in some aspects, process 1100 may include receiving, via a first CORESET, a first DCI message that schedules a first PUSCH message (block 1120). For example, the UE (such as by using communication manager 140 or reception component 1302, depicted in FIG. 13) may receive, via a first CORESET, a first DCI message that schedules a first PUSCH message, as described above.

As further shown in FIG. 11, in some aspects, process 1100 may include transmitting the first PUSCH message using a transmit power level, based at least in part on the first set of open-loop power control parameters or based at least in part on the second set of open-loop power control parameters, based at least in part on a CORESET pool index value associated with the first CORESET being the first CORESET pool index value or the second CORESET pool index value, respectively (block 1130). For example, the UE (such as by using communication manager 140 or transmission component 1304, depicted in FIG. 13) may transmit the first PUSCH message using a transmit power level, based at least in part on the first set of open-loop power control parameters or based at least in part on the second set of open-loop power control parameters, based at least in part on a CORESET pool index value associated with the first CORESET being the first CORESET pool index value or the second CORESET pool index value, respectively, as described above.

Process 1100 may include additional aspects, such as any single aspect or any combination of aspects described below or in connection with one or more other processes described elsewhere herein.

In a first additional aspect, the first CORESET pool index value is associated with a first TRP and the second CORESET pool index value is associated with a second TRP.

In a second additional aspect, alone or in combination with the first aspect, the first CORESET pool index value is associated with a first SRS resource set and the second CORESET pool index value is associated with a second SRS resource set.

In a third additional aspect, alone or in combination with one or more of the first and second aspects, the first DCI message includes an open-loop power control parameter set indication field, and the transmit power level is indicated based at least in part on the open-loop power control parameter set indication field and a set of P0 parameters and alpha parameters based at least in part on a value of the open-loop power control parameter set indication field, the first set of open-loop power control parameters based at least in part on the first CORESET being associated with the first CORESET pool index value, or the second set of open-loop power control parameters based at least in part on the first CORESET being associated with the second CORESET pool index value.

In a fourth additional aspect, alone or in combination with one or more of the first through third aspects, the first DCI message includes an SRI field, and the transmit power level is based at least in part on at least one of the SRI field based at least in part on a value of an open-loop power control parameter set indication field included in the first DCI message, the first set of open-loop power control parameters based at least in part on the first CORESET being associated with the first CORESET pool index value, or the second set of open-loop power control parameters based at least in part on the CORESET being associated with the second CORESET pool index value.

In a fifth additional aspect, alone or in combination with one or more of the first through fourth aspects, the first set of open-loop power control parameters and the second set of open-loop power control parameters are sets of P0 parameters (for example, are one or more P0-PUSCH-SetLists).

In a sixth additional aspect, alone or in combination with one or more of the first through fifth aspects, process 1100 includes receiving, via a second CORESET, a second DCI message scheduling a second PUSCH message, and transmitting the second PUSCH message using another transmit power level indicated by the first set of open-loop power control parameters based at least in part on the second CORESET being associated with the first CORESET pool index value, or the second set of open-loop power control parameters based at least in part on the second CORESET being associated with the second CORESET pool index value, and the first PUSCH message and the second PUSCH message are associated with a multiple DCI PUSCH message scheme, and the transmit power level is independent of the other transmit power level.

In a seventh additional aspect, alone or in combination with one or more of the first through sixth aspects, the first PUSCH message is not overlapping with the second PUSCH message in at least one of a time domain, a frequency domain, or a spatial domain.

In an eighth additional aspect, alone or in combination with one or more of the first through seventh aspects, the first PUSCH message is at least partially overlapping with the second PUSCH message in at least one of a time domain, a frequency domain, or a spatial domain.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a flowchart illustrating an example process 1200 performed, for example, by a base station, associated with open-loop power control parameter set indication for multi-DCI PUSCH messages, in accordance with the present disclosure. Example process 1200 is an example where the base station (for example, base station 110) performs operations associated with open-loop power control parameter set indication for multi-DCI PUSCH messages.

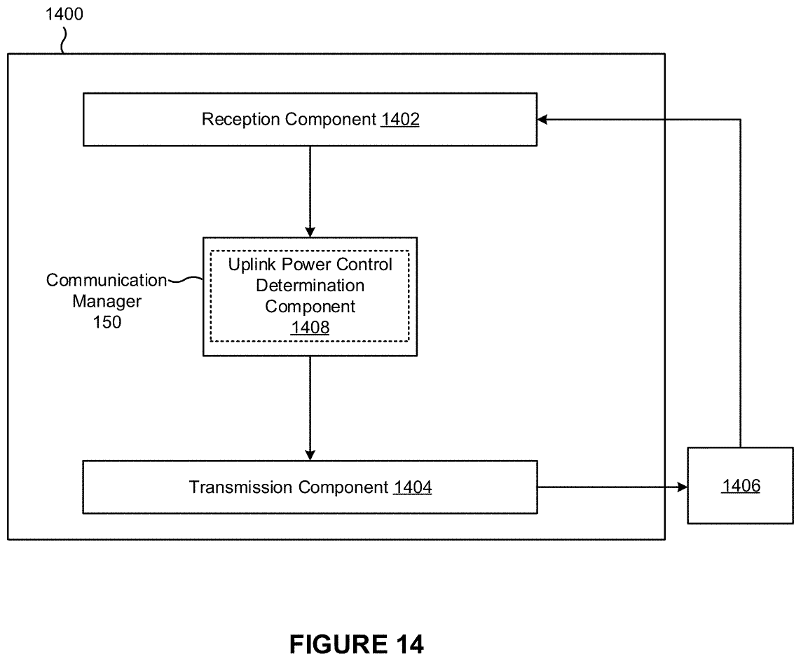

As shown in FIG. 12, in some aspects, process 1200 may include transmitting, to a UE, configuration information, associated with multiple DCI PUSCH messages, indicating a first set of open-loop power control parameters associated with a first CORESET pool index value and a second set of open-loop power control parameters associated with a second CORESET pool index value (block 1210). For example, the base station (such as by using communication manager 150 or transmission component 1404, depicted in FIG. 14) may transmit, to a UE, configuration information, associated with multiple DCI PUSCH messages, indicating a first set of open-loop power control parameters associated with a first CORESET pool index value and a second set of open-loop power control parameters associated with a second CORESET pool index value, as described above.

As further shown in FIG. 12, in some aspects, process 1200 may include transmitting, via a first CORESET, a first DCI message that schedules a first PUSCH message, the first DCI message indicating a transmit power level to be used by the UE based at least in part on the first set of open-loop power control parameters, the second set of open-loop power control parameters, and a CORESET pool index value associated with the first CORESET (block 1220). For example, the base station (such as by using communication manager 150 or transmission component 1404, depicted in FIG. 14) may transmit, via a first CORESET, a first DCI message that schedules a first PUSCH message, the first DCI message indicating a transmit power level to be used by the UE based at least in part on the first set of open-loop power control parameters, the second set of open-loop power control parameters, and a CORESET pool index value associated with the first CORESET, as described above.

As further shown in FIG. 12, in some aspects, process 1200 may include receiving, from the UE, the first PUSCH message that is transmitted by the UE using the transmit power level (block 1230). For example, the base station (such as by using communication manager 150 or reception component 1402, depicted in FIG. 14) may receive, from the UE, the first PUSCH message that is transmitted by the UE using the transmit power level, as described above.

Process 1200 may include additional aspects, such as any single aspect or any combination of aspects described below or in connection with one or more other processes described elsewhere herein.

In a first additional aspect, the first CORESET pool index value is associated with a first TRP and the second CORESET pool index value is associated with a second TRP.

In a second additional aspect, alone or in combination with the first aspect, the first CORESET pool index value is associated with a first SRS resource set and the second CORESET pool index value is associated with a second SRS resource set.

In a third additional aspect, alone or in combination with one or more of the first and second aspects, the first DCI message includes an open-loop power control parameter set indication field, and the transmit power level is indicated based at least in part on the open-loop power control parameter set indication field and a set of P0 parameters and alpha parameters based at least in part on a value of the open-loop power control parameter set indication field, the first set of open-loop power control parameters based at least in part on the first CORESET being associated with the first CORESET pool index value, or the second set of open-loop power control parameters based at least in part on the first CORESET being associated with the second CORESET pool index value.

In a fourth additional aspect, alone or in combination with one or more of the first through third aspects, the first DCI message includes an SRI field, and the transmit power level is indicated based at least in part on at least one of the SRI field based at least in part on a value of an open-loop power control parameter set indication field included in the first DCI message, the first set of open-loop power control parameters based at least in part on the first CORESET being associated with the first CORESET pool index value, or the second set of open-loop power control parameters based at least in part on the CORESET being associated with the second CORESET pool index value.

In a fifth additional aspect, alone or in combination with one or more of the first through fourth aspects, the first set of open-loop power control parameters and the second set of open-loop power control parameters are sets of P0 parameters (for example, are one or more P0-PUSCH-SetLists).

In a sixth additional aspect, alone or in combination with one or more of the first through fifth aspects, process 1200 includes transmitting, via a second CORESET, a second DCI message scheduling a second PUSCH message indicating another transmit power level to be used by the UE based at least in part on the first set of open-loop power control parameters, the second set of open-loop power control parameters, or a second CORESET pool index value associated with the second CORESET, and receiving the second PUSCH message that is transmitted using the other transmit power level, where the first PUSCH message and the second PUSCH message are associated with a multiple DCI PUSCH message scheme, and the transmit power level is independent of the other transmit power level.

In a seventh additional aspect, alone or in combination with one or more of the first through sixth aspects, the first PUSCH message is not overlapping with the second PUSCH message in at least one of a time domain, a frequency domain, or a spatial domain.

In an eighth additional aspect, alone or in combination with one or more of the first through seventh aspects, the first PUSCH message is at least partially overlapping with the second PUSCH message in at least one of a time domain, a frequency domain, or a spatial domain.

Although FIG. 12 shows example blocks of process 1200, in some aspects, process 1200 may include additional blocks, fewer blocks, different blocks, or differently arranged blocks than those depicted in FIG. 12. Additionally or alternatively, two or more of the blocks of process 1200 may be performed in parallel.

FIG. 13 is a diagram of an example apparatus 1300 for wireless communication in accordance with the present disclosure. The apparatus 1300 may be a UE, or a UE may include the apparatus 1300. In some aspects, the apparatus 1300 includes a reception component 1302, a transmission component 1304, and a communication manager 140, which may be in communication with one another (for example, via one or more buses). As shown, the apparatus 1300 may communicate with another apparatus 1306 (such as a UE, a base station, or another wireless communication device) using the reception component 1302 and the transmission component 1304.

In some aspects, the apparatus 1300 may be configured to perform one or more operations described herein in connection with FIGS. 8-10. Additionally or alternatively, the apparatus 1300 may be configured to perform one or more processes described herein, such as process 1100 of FIG. 11, or a combination thereof. In some aspects, the apparatus 1300 may include one or more components of the UE described above in connection with FIG. 2.

The reception component 1302 may receive communications, such as reference signals, control information, data communications, or a combination thereof, from the apparatus 1306. The reception component 1302 may provide received communications to one or more other components of the apparatus 1300, such as the communication manager 140. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1302 may include one or more antennas, a modem, a demodulator, a MIMO detector, a receive processor, a controller/processor, a memory, or a combination thereof, of the UE described above in connection with FIG. 2.

The transmission component 1304 may transmit communications, such as reference signals, control information, data communications, or a combination thereof, to the apparatus 1306. In some aspects, the communication manager 140 may generate communications and may transmit the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described above in connection with FIG. 2. In some aspects, the transmission component 1304 may be co-located with the reception component 1302 in a transceiver.

The communication manager 140 may receive or may cause the reception component 1302 to receive, from a base station, configuration information, associated with multiple DCI PUSCH messages, indicating a first set of open-loop power control parameters associated with a first CORESET pool index value and a second set of open-loop power control parameters associated with a second CORESET pool index value. The communication manager 140 may receive or may cause the reception component 1302 to receive, via a first CORESET, a first DCI message that schedules a first PUSCH message. The communication manager 140 may transmit or may cause the transmission component 1304 to transmit the first PUSCH message using a transmit power level, based at least in part on the first set of open-loop power control parameters or based at least in part on the second set of open-loop power control parameters, based at least in part on a CORESET pool index value associated with the first CORESET being the first CORESET pool index value or the second CORESET pool index value, respectively. In some aspects, the communication manager 140 may perform one or more operations described elsewhere herein as being performed by one or more components of the communication manager 140.

The communication manager 140 may include a controller/processor, a memory, or a combination thereof, of the UE described above in connection with FIG. 2. In some aspects, the communication manager 140 includes a set of components, such as a power control parameter determination component 1308, among other examples. Alternatively, the set of components may be separate and distinct from the communication manager 140. In some aspects, one or more components of the set of components may include or may be implemented within a controller/processor, a memory, or a combination thereof, of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive, from a base station, configuration information, associated with multiple DCI PUSCH messages, indicating a first set of open-loop power control parameters associated with a first CORESET pool index value and a second set of open-loop power control parameters associated with a second CORESET pool index value. The reception component 1302 may receive, via a first CORESET, a first DCI message that schedules a first PUSCH message. The transmission component 1304 may transmit the first PUSCH message using a transmit power level, indicated by the first set of open-loop power control parameters or indicated by the second set of open-loop power control parameters, based at least in part on a CORESET pool index value associated with the first CORESET being the first CORESET pool index value or the second CORESET pool index value.

The power control parameter determination component 1308 may determine a set of open-loop power control parameters, from the first set of open-loop power control parameters and the second set of open-loop power control parameters, to use for the first PUSCH message based at least in part on the CORESET pool index value associated with the first CORESET.

The reception component 1302 may receive, via a second CORESET, a second DCI message scheduling a second PUSCH message.

The transmission component 1304 may transmit the second PUSCH message using another transmit power level indicated by the first set of open-loop power control parameters based at least in part on the second CORESET being associated with the first CORESET pool index value, or the second set of open-loop power control parameters based at least in part on the second CORESET being associated with the second CORESET pool index value.

The quantity and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally or alternatively, a set of (one or more) components shown in FIG. 13 may perform one or more functions described as being performed by another set of components shown in FIG. 13.

FIG. 14 is a diagram of an example apparatus 1400 for wireless communication in accordance with the present disclosure. The apparatus 1400 may be a base station, or a base station may include the apparatus 1400. In some aspects, the apparatus 1400 includes a reception component 1402, a transmission component 1404, and a communication manager 150, which may be in communication with one another (for example, via one or more buses). As shown, the apparatus 1400 may communicate with another apparatus 1406 (such as a UE, a base station, or another wireless communication device) using the reception component 1402 and the transmission component 1404.

In some aspects, the apparatus 1400 may be configured to perform one or more operations described herein in connection with FIGS. 8-10. Additionally or alternatively, the apparatus 1400 may be configured to perform one or more processes described herein, such as process 1200 of FIG. 12, or a combination thereof. In some aspects, the apparatus 1400 may include one or more components of the base station described above in connection with FIG. 2.

The reception component 1402 may receive communications, such as reference signals, control information, data communications, or a combination thereof, from the apparatus 1406. The reception component 1402 may provide received communications to one or more other components of the apparatus 1400, such as the communication manager 150. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1402 may include one or more antennas, a modem, a demodulator, a MIMO detector, a receive processor, a controller/processor, a memory, or a combination thereof, of the base station described above in connection with FIG. 2.

The transmission component 1404 may transmit communications, such as reference signals, control information, data communications, or a combination thereof, to the apparatus 1406. In some aspects, the communication manager 150 may generate communications and may transmit the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the base station described above in connection with FIG. 2. In some aspects, the transmission component 1404 may be co-located with the reception component 1402 in a transceiver.

The communication manager 150 may transmit or may cause the transmission component 1404 to transmit, to a UE, configuration information, associated with multiple DCI PUSCH messages, indicating a first set of open-loop power control parameters associated with a first CORESET pool index value and a second set of open-loop power control parameters associated with a second CORESET pool index value. The communication manager 150 may transmit or may cause the transmission component 1404 to transmit, via a first CORESET, a first DCI message that schedules a first PUSCH message, the first DCI message indicating a transmit power level to be used by the UE based at least in part on the first set of open-loop power control parameters, the second set of open-loop power control parameters, and a CORESET pool index value associated with the first CORESET. The communication manager 150 may receive or may cause the reception component 1402 to receive, from the UE, the first PUSCH message that is transmitted by the UE using the transmit power level. In some aspects, the communication manager 150 may perform one or more operations described elsewhere herein as being performed by one or more components of the communication manager 150.

The communication manager 150 may include a controller/processor, a memory, a scheduler, a communication unit, or a combination thereof, of the base station described above in connection with FIG. 2. In some aspects, the communication manager 150 includes a set of components, such as an uplink power control determination component 1408, among other examples. Alternatively, the set of components may be separate and distinct from the communication manager 150. In some aspects, one or more components of the set of components may include or may be implemented within a controller/processor, a memory, a scheduler, a communication unit, or a combination thereof, of the base station described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The transmission component 1404 may transmit, to a UE, configuration information, associated with multiple DCI PUSCH messages, indicating a first set of open-loop power control parameters associated with a first CORESET pool index value and a second set of open-loop power control parameters associated with a second CORESET pool index value. The transmission component 1404 may transmit, via a first CORESET, a first DCI message that schedules a first PUSCH message, the first DCI message indicating a transmit power level to be used by the UE based at least in part on the first set of open-loop power control parameters, the second set of open-loop power control parameters, and a CORESET pool index value associated with the first CORESET. The reception component 1402 may receive, from the UE, the first PUSCH message that is transmitted by the UE using the transmit power level.

The uplink power control determination component 1408 may determine one or more OLPC parameters, to indicate via the first DCI message, from the first set of open-loop power control parameters or the second set of open-loop power control parameters based at least in part on the CORESET pool index value associated with the first CORESET.

The transmission component 1404 may transmit, via a second CORESET, a second DCI message scheduling a second PUSCH message indicating another transmit power level to be used by the UE based at least in part on the first set of open-loop power control parameters, the second set of open-loop power control parameters, or a second CORESET pool index value associated with the second CORESET.

The reception component 1402 may receive the second PUSCH message that is transmitted using the other transmit power level, the first PUSCH message and the second PUSCH message are associated with a multiple DCI PUSCH message scheme, and the transmit power level is independent of the other transmit power level.

The quantity and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: receiving, from a base station, configuration information, associated with multiple downlink control information (DCI) physical uplink shared channel (PUSCH) messages, indicating a first set of open-loop power control parameters associated with a first control resource set (CORESET) pool index value and a second set of open-loop power control parameters associated with a second CORESET pool index value; receiving, via a first CORESET, a first DCI message that schedules a first PUSCH message; and transmitting the first PUSCH message using a transmit power level, based at least in part on the first set of open-loop power control parameters or based at least in part on the second set of open-loop power control parameters, based at least in part on a CORESET pool index value associated with the first CORESET being the first CORESET pool index value or the second CORESET pool index value, respectively.

Aspect 2: The method of Aspect 1, wherein the first CORESET pool index value is associated with a first transmission reception point (TRP) and the second CORESET pool index value is associated with a second TRP.

Aspect 3: The method of any of Aspects 1-2, wherein the first CORESET pool index value is associated with a first sounding reference signal (SRS) resource set and the second CORESET pool index value is associated with a second SRS resource set.

Aspect 4: The method of any of Aspects 1-3, wherein the first DCI message includes an open-loop power control parameter set indication field, and wherein the transmit power level is indicated based at least in part on the open-loop power control parameter set indication field and: a set of target received PUSCH power level (P0) parameters and pathloss adjustment factor (alpha) parameters based at least in part on a value of the open-loop power control parameter set indication field; the first set of open-loop power control parameters based at least in part on the first CORESET being associated with the first CORESET pool index value; or the second set of open-loop power control parameters based at least in part on the first CORESET being associated with the second CORESET pool index value.

Aspect 5: The method of any of Aspects 1-4, wherein the first DCI message includes a sounding reference signal (SRS) resource indicator (SRI) field, and wherein the transmit power level is based at least in part on at least one of: the SRI field based at least in part on a value of an open-loop power control parameter set indication field included in the first DCI message; the first set of open-loop power control parameters based at least in part on the first CORESET being associated with the first CORESET pool index value; or the second set of open-loop power control parameters based at least in part on the CORESET being associated with the second CORESET pool index value.

Aspect 6: The method of any of Aspects 1-5, wherein the first set of open-loop power control parameters and the second set of open-loop power control parameters are sets of target received PUSCH power level (P0) parameters.

Aspect 7: The method of any of Aspects 1-6, further comprising: receiving, via a second CORESET, a second DCI message scheduling a second PUSCH message; and transmitting the second PUSCH message using another transmit power level indicated by: the first set of open-loop power control parameters based at least in part on the second CORESET being associated with the first CORESET pool index value, or the second set of open-loop power control parameters based at least in part on the second CORESET being associated with the second CORESET pool index value; and wherein the first PUSCH message and the second PUSCH message are associated with a multiple DCI PUSCH message scheme, and wherein the transmit power level is independent of the other transmit power level.

Aspect 8: The method of Aspect 7, wherein the first PUSCH message is not overlapping with the second PUSCH message in at least one of a time domain, a frequency domain, or a spatial domain.

Aspect 9: The method of Aspect 7, wherein the first PUSCH message is at least partially overlapping with the second PUSCH message in at least one of a time domain, a frequency domain, or a spatial domain.

Aspect 10: A method of wireless communication performed by a base station, comprising: transmitting, to a user equipment (UE), configuration information, associated with multiple downlink control information (DCI) physical uplink shared channel (PUSCH) messages, indicating a first set of open-loop power control parameters associated with a first control resource set (CORESET) pool index value and a second set of open-loop power control parameters associated with a second CORESET pool index value; transmitting, via a first CORESET, a first DCI message that schedules a first PUSCH message, the first DCI message indicating a transmit power level to be used by the UE based at least in part on the first set of open-loop power control parameters, the second set of open-loop power control parameters, and a CORESET pool index value associated with the first CORESET; and receiving, from the UE, the first PUSCH message that is transmitted by the UE using the transmit power level.

Aspect 11: The method of Aspect 10, wherein the first CORESET pool index value is associated with a first transmission reception point (TRP) and the second CORESET pool index value is associated with a second TRP.

Aspect 12: The method of any of Aspects 10-11, wherein the first CORESET pool index value is associated with a first sounding reference signal (SRS) resource set and the second CORESET pool index value is associated with a second SRS resource set.

Aspect 13: The method of any of Aspects 10-12, wherein the first DCI message includes an open-loop power control parameter set indication field, and wherein the transmit power level is indicated based at least in part on the open-loop power control parameter set indication field and: a set of target received PUSCH power level (P0) parameters and pathloss adjustment factor (alpha) parameters based at least in part on a value of the open-loop power control parameter set indication field; the first set of open-loop power control parameters based at least in part on the first CORESET being associated with the first CORESET pool index value; or the second set of open-loop power control parameters based at least in part on the first CORESET being associated with the second CORESET pool index value.

Aspect 14: The method of any of Aspects 10-13, wherein the first DCI message includes a sounding reference signal (SRS) resource indicator (SRI) field, and wherein the transmit power level is indicated based at least in part on at least one of: the SRI field based at least in part on a value of an open-loop power control parameter set indication field included in the first DCI message; the first set of open-loop power control parameters based at least in part on the first CORESET being associated with the first CORESET pool index value; or the second set of open-loop power control parameters based at least in part on the CORESET being associated with the second CORESET pool index value.

Aspect 15: The method of any of Aspects 10-14, wherein the first set of open-loop power control parameters and the second set of open-loop power control parameters are sets of target received PUSCH power level (P0) parameters.

Aspect 16: The method of any of Aspects 10-15, further comprising: transmitting, via a second CORESET, a second DCI message scheduling a second PUSCH message indicating another transmit power level to be used by the UE based at least in part on the first set of open-loop power control parameters, the second set of open-loop power control parameters, or a second CORESET pool index value associated with the second CORESET; and receiving the second PUSCH message that is transmitted using the other transmit power level, wherein the first PUSCH message and the second PUSCH message are associated with a multiple DCI PUSCH message scheme, and wherein the transmit power level is independent of the other transmit power level.

Aspect 17: The method of Aspect 16, wherein the first PUSCH message is not overlapping with the second PUSCH message in at least one of a time domain, a frequency domain, or a spatial domain.

Aspect 18: The method of Aspect 16, wherein the first PUSCH message is at least partially overlapping with the second PUSCH message in at least one of a time domain, a frequency domain, or a spatial domain.

Aspect 19: An apparatus for wireless communication at a device, comprising a processor; memory coupled with the processor; and instructions stored in the memory and executable by the processor to cause the apparatus to perform the method of one or more of Aspects 1-9.

Aspect 20: A device for wireless communication, comprising a memory and one or more processors coupled to the memory, the one or more processors configured to perform the method of one or more of Aspects 1-9.

Aspect 21: An apparatus for wireless communication, comprising at least one means for performing the method of one or more of Aspects 1-9.

Aspect 22: A non-transitory computer-readable medium storing code for wireless communication, the code comprising instructions executable by a processor to perform the method of one or more of Aspects 1-9.

Aspect 23: A non-transitory computer-readable medium storing a set of instructions for wireless communication, the set of instructions comprising one or more instructions that, when executed by one or more processors of a device, cause the device to perform the method of one or more of Aspects 1-9.

Aspect 24: An apparatus for wireless communication at a device, comprising a processor; memory coupled with the processor; and instructions stored in the memory and executable by the processor to cause the apparatus to perform the method of one or more of Aspects 10-18.

Aspect 25: A device for wireless communication, comprising a memory and one or more processors coupled to the memory, the one or more processors configured to perform the method of one or more of Aspects 10-18.

Aspect 26: An apparatus for wireless communication, comprising at least one means for performing the method of one or more of Aspects 10-18.

Aspect 27: A non-transitory computer-readable medium storing code for wireless communication, the code comprising instructions executable by a processor to perform the method of one or more of Aspects 10-18.

Aspect 28: A non-transitory computer-readable medium storing a set of instructions for wireless communication, the set of instructions comprising one or more instructions that, when executed by one or more processors of a device, cause the device to perform the method of one or more of Aspects 10-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. A user equipment (UE) for wireless communication, comprising:
at least one processor; and
at least one memory communicatively coupled with the at least one processor and storing processor-readable code that, when executed by the at least one processor, is configured to cause the UE to:
receive, from a base station, configuration information, associated with multiple downlink control information (DCI) physical uplink shared channel (PUSCH) messages, indicating a first set of open-loop power control parameters associated with a first control resource set (CORESET) pool index value and a second set of open-loop power control parameters associated with a second CORESET pool index value;
receive, via a first CORESET, a first DCI message that schedules a first PUSCH message; and
transmit the first PUSCH message using a transmit power level, based at least in part on the first set of open-loop power control parameters or based at least in part on the second set of open-loop power control parameters, based at least in part on a CORESET pool index value associated with the first CORESET being the first CORESET pool index value or the second CORESET pool index value, respectively.

2. The UE of claim 1, wherein the first CORESET pool index value is associated with a first transmission reception point (TRP) and the second CORESET pool index value is associated with a second TRP.

3. The UE of claim 1, wherein the first CORESET pool index value is associated with a first sounding reference signal (SRS) resource set and the second CORESET pool index value is associated with a second SRS resource set.

4. The UE of claim 1, wherein the first DCI message includes an open-loop power control parameter set indication field, and wherein the transmit power level is indicated based at least in part on the open-loop power control parameter set indication field and:
a set of target received PUSCH power level (P0) parameters and pathloss adjustment factor (alpha) parameters based at least in part on a value of the open-loop power control parameter set indication field;
the first set of open-loop power control parameters based at least in part on the first CORESET being associated with the first CORESET pool index value; or
the second set of open-loop power control parameters based at least in part on the first CORESET being associated with the second CORESET pool index value.

5. The UE of claim 1, wherein the first DCI message includes a sounding reference signal (SRS) resource indicator (SRI) field, and wherein the transmit power level is based at least in part on at least one of:
the SRI field based at least in part on a value of an open-loop power control parameter set indication field included in the first DCI message;
the first set of open-loop power control parameters based at least in part on the first CORESET being associated with the first CORESET pool index value; or
the second set of open-loop power control parameters based at least in part on the CORESET being associated with the second CORESET pool index value.

6. The UE of claim 1, wherein the first set of open-loop power control parameters and the second set of open-loop power control parameters are sets of target received PUSCH power level (P0) parameters.

7. The UE of claim 1, wherein the at least one memory further stores processor-readable code configured to cause the UE to:
receive, via a second CORESET, a second DCI message scheduling a second PUSCH message; and
transmit the second PUSCH message using another transmit power level indicated by:
the first set of open-loop power control parameters based at least in part on the second CORESET being associated with the first CORESET pool index value, or
the second set of open-loop power control parameters based at least in part on the second CORESET being associated with the second CORESET pool index value; and
wherein the first PUSCH message and the second PUSCH message are associated with a multiple DCI PUSCH message scheme, and wherein the transmit power level is independent of the other transmit power level.

8. The UE of claim 7, wherein the first PUSCH message is not overlapping with the second PUSCH message in at least one of a time domain, a frequency domain, or a spatial domain.

9. The UE of claim 7, wherein the first PUSCH message is at least partially overlapping with the second PUSCH message in at least one of a time domain, a frequency domain, or a spatial domain.

10. A base station for wireless communication, comprising:
at least one processor; and
at least one memory communicatively coupled with the at least one processor and storing processor-readable code that, when executed by the at least one processor, is configured to cause the base station to:
transmit, to a user equipment (UE), configuration information, associated with multiple downlink control information (DCI) physical uplink shared channel (PUSCH) messages, indicating a first set of open-loop power control parameters associated with a first control resource set (CORESET) pool index value and a second set of open-loop power control parameters associated with a second CORESET pool index value;
transmit, via a first CORESET, a first DCI message that schedules a first PUSCH message, the first DCI message indicating a transmit power level to be used by the UE based at least in part on the first set of open-loop power control parameters, the second set of open-loop power control parameters, and a CORESET pool index value associated with the first CORESET; and
receive, from the UE, the first PUSCH message that is transmitted by the UE using the transmit power level.

11. The base station of claim 10, wherein the first CORESET pool index value is associated with a first transmission reception point (TRP) and the second CORESET pool index value is associated with a second TRP.

12. The base station of claim 10, wherein the first CORESET pool index value is associated with a first sounding reference signal (SRS) resource set and the second CORESET pool index value is associated with a second SRS resource set.

13. The base station of claim 10, wherein the first DCI message includes an open-loop power control parameter set indication field, and wherein the transmit power level is indicated based at least in part on the open-loop power control parameter set indication field and:
a set of target received PUSCH power level (P0) parameters and pathloss adjustment factor (alpha) parameters based at least in part on a value of the open-loop power control parameter set indication field;
the first set of open-loop power control parameters based at least in part on the first CORESET being associated with the first CORESET pool index value; or
the second set of open-loop power control parameters based at least in part on the first CORESET being associated with the second CORESET pool index value.

14. The base station of claim 10, wherein the first DCI message includes a sounding reference signal (SRS) resource indicator (SRI) field, and wherein the transmit power level is indicated based at least in part on at least one of:
the SRI field based at least in part on a value of an open-loop power control parameter set indication field included in the first DCI message;
the first set of open-loop power control parameters based at least in part on the first CORESET being associated with the first CORESET pool index value; or
the second set of open-loop power control parameters based at least in part on the CORESET being associated with the second CORESET pool index value.

15. The base station of claim 10, wherein the first set of open-loop power control parameters and the second set of open-loop power control parameters are sets of target received PUSCH power level (P0) parameters.

16. A method of wireless communication performed by a user equipment (UE), comprising:
receiving, from a base station, configuration information, associated with multiple downlink control information (DCI) physical uplink shared channel (PUSCH) messages, indicating a first set of open-loop power control parameters associated with a first control resource set (CORESET) pool index value and a second set of open-loop power control parameters associated with a second CORESET pool index value;
receiving, via a first CORESET, a first DCI message that schedules a first PUSCH message; and
transmitting the first PUSCH message using a transmit power level, based at least in part on the first set of open-loop power control parameters or based at least in part on the second set of open-loop power control parameters, based at least in part on a CORESET pool index value associated with the first CORESET being the first CORESET pool index value or the second CORESET pool index value, respectively.

17. The method of claim 16, wherein the first CORESET pool index value is associated with a first transmission reception point (TRP) and the second CORESET pool index value is associated with a second TRP.

18. The method of claim 16, wherein the first CORESET pool index value is associated with a first sounding reference signal (SRS) resource set and the second CORESET pool index value is associated with a second SRS resource set.

19. The method of claim 16, wherein the first DCI message includes an open-loop power control parameter set indication field, and wherein the transmit power level is indicated based at least in part on the open-loop power control parameter set indication field and:
a set of target received PUSCH power level (P0) parameters and pathloss adjustment factor (alpha) parameters based at least in part on a value of the open-loop power control parameter set indication field;
the first set of open-loop power control parameters based at least in part on the first CORESET being associated with the first CORESET pool index value; or
the second set of open-loop power control parameters based at least in part on the first CORESET being associated with the second CORESET pool index value.

20. The method of claim 16, wherein the first DCI message includes a sounding reference signal (SRS) resource indicator (SRI) field, and wherein the transmit power level is based at least in part on at least one of:
the SRI field based at least in part on a value of an open-loop power control parameter set indication field included in the first DCI message;
the first set of open-loop power control parameters based at least in part on the first CORESET being associated with the first CORESET pool index value; or
the second set of open-loop power control parameters based at least in part on the CORESET being associated with the second CORESET pool index value.

21. The method of claim 16, wherein the first set of open-loop power control parameters and the second set of open-loop power control parameters are sets of target received PUSCH power level (P0) parameters.

22. The method of claim 16, further comprising:
receiving, via a second CORESET, a second DCI message scheduling a second PUSCH message; and
transmitting the second PUSCH message using another transmit power level indicated by:
the first set of open-loop power control parameters based at least in part on the second CORESET being associated with the first CORESET pool index value, or
the second set of open-loop power control parameters based at least in part on the second CORESET being associated with the second CORESET pool index value; and
wherein the first PUSCH message and the second PUSCH message are associated with a multiple DCI PUSCH message scheme, and wherein the transmit power level is independent of the other transmit power level.

23. The method of claim 22, wherein the first PUSCH message is not overlapping with the second PUSCH message in at least one of a time domain, a frequency domain, or a spatial domain.

24. The method of claim 22, wherein the first PUSCH message is at least partially overlapping with the second PUSCH message in at least one of a time domain, a frequency domain, or a spatial domain.

25. A method of wireless communication performed by a base station, comprising:
transmitting, to a user equipment (UE), configuration information, associated with multiple downlink control information (DCI) physical uplink shared channel (PUSCH) messages, indicating a first set of open-loop power control parameters associated with a first control resource set (CORESET) pool index value and a second set of open-loop power control parameters associated with a second CORESET pool index value;
transmitting, via a first CORESET, a first DCI message that schedules a first PUSCH message, the first DCI message indicating a transmit power level to be used by the UE based at least in part on the first set of open-loop power control parameters, the second set of open-loop power control parameters, and a CORESET pool index value associated with the first CORESET; and
receiving, from the UE, the first PUSCH message that is transmitted by the UE using the transmit power level.

26. The method of claim 25, wherein the first CORESET pool index value is associated with a first transmission reception point (TRP) and the second CORESET pool index value is associated with a second TRP.

27. The method of claim 25, wherein the first CORESET pool index value is associated with a first sounding reference signal (SRS) resource set and the second CORESET pool index value is associated with a second SRS resource set.

28. The method of claim 25, wherein the first DCI message includes an open-loop power control parameter set indication field, and wherein the transmit power level is indicated based at least in part on the open-loop power control parameter set indication field and:
a set of target received PUSCH power level (P0) parameters and pathloss adjustment factor (alpha) parameters based at least in part on a value of the open-loop power control parameter set indication field;
the first set of open-loop power control parameters based at least in part on the first CORESET being associated with the first CORESET pool index value; or
the second set of open-loop power control parameters based at least in part on the first CORESET being associated with the second CORESET pool index value.

29. The method of claim 25, wherein the first DCI message includes a sounding reference signal (SRS) resource indicator (SRI) field, and wherein the transmit power level is indicated based at least in part on at least one of:
the SRI field based at least in part on a value of an open-loop power control parameter set indication field included in the first DCI message;
the first set of open-loop power control parameters based at least in part on the first CORESET being associated with the first CORESET pool index value; or
the second set of open-loop power control parameters based at least in part on the CORESET being associated with the second CORESET pool index value.

30. The method of claim 25, wherein the first set of open-loop power control parameters and the second set of open-loop power control parameters are sets of target received PUSCH power level (P0) parameters.
